(19) United States
(12) Patent Application Publication
(10) Pub. No.: US 2014/0104151 A1
(43) Pub. Date: Apr. 17, 2014

(54) LIQUID CRYSTAL DISPLAY DEVICE

(71) Applicant: Semiconductor Energy Laboratory Co., Ltd., Atsugi-shi (JP)

(72) Inventors: Shunpei YAMAZAKI, Setagaya (JP); Hiroyuki MIYAKE, Atsugi (JP)

(73) Assignee: Semiconductor Energy Laboratory Co., Ltd., Atsugi-shi (JP)

(21) Appl. No.: 14/050,931

(22) Filed: Oct. 10, 2013

(30) Foreign Application Priority Data
Oct. 12, 2012 (JP) 2012-226973

(51) Int. Cl. G09G 3/36

(52) U.S. Cl. CPC G09G 3/3614
USPC 345/94

(57) ABSTRACT

A liquid crystal display device which has higher definition and reduced power consumption while its image quality is maintained is provided. A switching transistor of an active matrix liquid crystal display device is formed using a transistor having an extremely low off-state current to reduce the area of a capacitor; the capacitance value of parasitic capacitance formed by the left end of a pixel electrode and a first source line is made to be approximately the same as that of parasitic capacitance formed by the right end of the pixel electrode and a second source line; and video signals having one polarity are input to the first source line, and video signals having the other polarity are input to the second source line.

### BACKGROUND OF THE INVENTION

1. Field of the Invention

The present invention relates to a liquid crystal display device, particularly an active matrix liquid crystal display device having a transistor including an oxide semiconductor.

2. Description of the Related Art

Recently, a metal oxide called an oxide semiconductor has attracted attention as an active layer of a new semiconductor element instead of amorphous silicon or polysilicon. An oxide semiconductor exhibits both high mobility which is a feature of polysilicon and microcrystalline silicon and uniform element characteristics, which are a feature of amorphous silicon.

Examples of such an oxide semiconductor are tungsten oxide, tin oxide, indium oxide, and zinc oxide. In particular, an In—Ga—Zn-based oxide semiconductor which is a metal oxide including indium, gallium, and zinc brings about excellent transistor characteristics, and thus has attracted attention as an active layer of a next-generation transistor (see Patent Documents 1 and 2).

Further, the current value in an off state (hereinafter, referred to as an off-state current) of a transistor including an In—Ga—Zn-based oxide semiconductor is extremely lower than that of a conventional transistor including a silicon-based semiconductor (see Patent Document 3).

### REFERENCE

### Patent Document

[Patent Document 1] Japanese Published Patent Application No. 2007-96055
[Patent Document 2] Japanese Published Patent Application No. 2007-123861
[Patent Document 3] Japanese Published Patent Application No. 2011-145290

### SUMMARY OF THE INVENTION

Recently, reducing the power consumption of electronic devices has been required for energy saving, and reducing the power consumption of liquid crystal display devices has also been required. In particular, further reducing power consumption is needed for portable electronic devices such as mobile phones, mobile phones with advanced features (smartphones), tablet terminals, and notebook PCs because reducing the power consumption of their display devices directly affects the length of continuous operating time.

Further, in the case of such a portable electronic device, the distance between the liquid crystal display device and the user's eyes is short; thus, increasing the definition of the liquid crystal display device is needed. Further, increasing the definition is needed also for a large-sized liquid crystal display device such as a TV in order to have image quality better than full high-definition image quality.

When the definition of a liquid crystal display device is increased for these reasons, the area of each pixel is inevitably reduced, and the areas of a transistor and a capacitor to a pixel are increased. Accordingly, in a transmissive liquid crystal display device, a region of a pixel through which light emitted from a backlight transmits is reduced, so that the aperture ratio is decreased. When the aperture ratio is decreased, the light of the backlight has to be stronger in order to compensate the luminance. Accordingly, the power consumption of the backlight is increased, so that the power consumption of the liquid crystal display device is also increased.

In order to increase the definition of the liquid crystal display device and reduce the power consumption thereof, the area of pixels needs to be reduced and the aperture ratio needs to be improved. For example, when the area occupied by the capacitor is reduced, the aperture ratio is improved; however, the capacitance value is also lowered. Thus, the period during which the potential of a pixel electrode can be held becomes shorter, so that a problem of a reduction in image quality occurs.

In view of the above problems, it is an object of one embodiment of the present invention to provide a liquid crystal display device which has higher definition and reduced power consumption while its image quality is maintained.

### <Change of Potential of Pixel Electrode Due to Leakage Current>

In the above object, in order to maintain the image quality, it is required to hold the potential of the pixel electrode for a long time. While the potential of the pixel electrode is held, the pixel electrode is ideally insulated from a source line by a transistor so as to be in a floating state and holds charge. However, when leakage current (off-state current) between a source and a drain of the transistor is increased, the charge moves from the pixel electrode to the source line, so that the potential of the pixel electrode is changed. That is, in an active matrix liquid crystal display device, the holding time of the potential of a pixel electrode largely depends on the off-state current of a transistor of each pixel. In other words, the use of a transistor having an extremely low off-state current for the pixel makes it possible to hold the potential of the pixel electrode for a long time.

As described above, the off-state current of the transistor including an oxide semiconductor is extremely lower than that of the conventional transistor including a silicon-based semiconductor. The use of such a transistor including an oxide semiconductor for each pixel makes it possible to reduce the area occupied by the capacitor while the holding time of the potential of the pixel electrode is maintained.

As described above, in the active matrix liquid crystal display device of the present invention, the area of the capacitor is reduced with the use of the transistor having an extremely low off-state current, so that a reduction in aperture ratio due to an increase in definition is made smaller.

### <Change of Potential of Pixel Electrode Due to Crosstalk>

As described above, the use of the transistor having an extremely low off-state current can suppress the change of the potential of a pixel electrode due to leakage current; however, a factor causing the change of the potential of the pixel electrode is not limited to this. While the potential of the pixel electrode is held, the pixel electrode is in a floating state; in the case where the capacitance value of the capacitor is small, a phenomenon called crosstalk occurs in which the potential of the pixel electrode is changed by parasitic capacitance formed by the pixel electrode.

Parasitic capacitance which causes crosstalk is formed mainly between a pixel electrode and a source line. When the potential of the source line is changed by video signals input to the source line while the potential of the pixel electrode is held, the potential of the pixel electrode is also changed in accordance with the change of the potential of the source line.

Here, the pixel electrode is positioned between a first source line electrically connected to the pixel electrode and a second source line electrically connected to an adjacent pixel electrode. Both first parasitic capacitance formed between the pixel electrode and the first source line and second parasitic capacitance formed between the pixel electrode and the second source line make the potential of the pixel electrode change.

In the active matrix liquid crystal display device shown in the present invention, the polarity of a video signal input to the first source line connected to one pixel is different from that of a video signal input to the second source line which is provided to be adjacent to the first source line with the pixel electrode of the pixel positioned therebetween. Accordingly, the polarity of the potential caused by the first parasitic capacitance is different from that of the potential caused by the second parasitic capacitance; thus, the change of the potential of the pixel electrode due to crosstalk can be reduced.

Further, the capacitance value of the first parasitic capacitance formed between the pixel electrode and the first source line and the capacitance value of the second parasitic capacitance formed between the pixel electrode and the second source line are adjusted to be approximately the same, so that the potential caused by the first parasitic capacitance and the potential caused by the second parasitic capacitance have different polarities and approximately the same absolute value; thus, the change of the potential of the pixel electrode due to crosstalk can be further reduced.

The area of the capacitor is reduced in the above manner, so that a reduction in aperture ratio due to an increase in definition is made smaller. Specifically, the following embodiment can be employed, for example.

One embodiment of the present invention is a liquid crystal display device including a plurality of gate lines extending in a row direction, a plurality of source lines extending in a column direction, and a plurality of pixels which is electrically connected to the plurality of gate lines and the plurality of source lines and is provided in a matrix. One of the plurality of pixels includes a transistor which is electrically connected to the first gate line and the first source line and includes an oxide semiconductor, and a pixel electrode which is electrically connected to the transistor. The polarities of video signals input to the first source line are different from those of video signals input to the second source line which is provided to be adjacent to the first source line with the pixel electrode positioned therebetween. The difference between the capacitance value of parasitic capacitance formed between the pixel electrode and the second source line and the capacitance value of parasitic capacitance formed between the pixel electrode and the first source line is greater than or equal to −10% and smaller than or equal to 10%.

In the above liquid crystal display device, the pixel electrode preferably has a planar shape which is almost symmetrical about a bisector of the first source line and the second source line. It is preferable that the distance between a first wiring and the end portion of the pixel electrode on the first wiring side be approximately the same as that between a second wiring and the end portion of the pixel electrode on the second wiring side.

Further, it is preferable that a plurality of capacitor lines be provided in the same layer as the plurality of gate lines, and in each of the pixels, the capacitance value of the capacitor including one of the capacitor lines be smaller than or equal to 30 fF. It is preferable that 300 or more of the gate lines and 300 or more of the source lines be provided in each inch. It is preferable that the oxide semiconductor have a wider band gap and a lower intrinsic carrier density than silicon.

In addition, in this specification and the like, the term such as “electrode” or “wiring” does not limit a function of a component. For example, an “electrode” is sometimes used as part of a “wiring”, and vice versa. Furthermore, the term “electrode” or “wiring” can include the case where a plurality of “electrodes” or “wirings” is formed in an integrated manner.

Functions of a “source” and a “drain” are sometimes replaced with each other when a transistor of opposite polarity is used or when the direction of current flowing is changed in circuit operation, for example. Therefore, the terms “source” and “drain” can be used to denote the drain and the source, respectively, in this specification.

Note that in this specification and the like, the term “electrically connected” includes the case where components are connected through an object having any electric function. There is no particular limitation on an object having any electric function as long as electric signals can be transmitted and received between components that are connected through the object. Examples of an “object having any electric function” are a switching element such as a transistor, a resistor, an inductor, a capacitor, and an element with a variety of functions as well as an electrode and a wiring.

Unless otherwise specified, in the case of an n-channel transistor, off-state current in this specification is current that flows between a source electrode and a drain electrode when the potential of the drain electrode is higher than that of the source electrode and that of a gate electrode while the voltage between the gate electrode and the source electrode is less than or equal to zero. Further, in this specification, in the case of a p-channel transistor, off-state current is current that flows between a source electrode and a drain electrode when the potential of the drain electrode is lower than that of the source electrode or that of a gate electrode while the voltage between the gate electrode and the source is greater than or equal to zero.

In this specification, a term “parallel” indicates that the angle formed between two straight lines is greater than or equal to −10° and less than or equal to 10°, and accordingly also includes the case where the angle is greater than or equal to −5° and less than or equal to 5°. In addition, a term “perpendicular” indicates that the angle formed between two straight lines is from 80° to 100°, and accordingly includes a case where the angle is from 85° to 95°.

According to one embodiment of the disclosed invention, a liquid crystal display device which has higher definition and reduced power consumption while its image quality is maintained can be provided.

### BRIEF DESCRIPTION OF THE DRAWINGS

FIGS. 1A and 1B are equivalent circuit diagrams of a pixel portion and a pixel of a liquid crystal display device of one embodiment of the present invention.

FIG. 2 is an equivalent circuit diagram of a pixel of a liquid crystal display device of one embodiment of the present invention.

FIGS. 3A to 3D are schematic diagrams of inversion driving of a liquid crystal display device.

FIGS. 4A to 4D are schematic diagrams of inversion driving of a liquid crystal display device.

FIGS. 5A and 5B are each an equivalent circuit diagram of a pixel of a liquid crystal display device of one embodiment of the present invention.

FIG. 6 is a timing chart showing an example of operation of a liquid crystal display device of one embodiment of the present invention.

FIG. 7 is a plan view of a pixel of a liquid crystal display device of one embodiment of the present invention.

FIGS. 8A to 8C are cross-sectional views of a pixel of a liquid crystal display device of one embodiment of the present invention.

FIGS. 9A and 9B are cross-sectional views of a pixel of a liquid crystal display device of one embodiment of the present invention.

FIGS. 10A and 10B are cross-sectional views of a pixel of a liquid crystal display device of one embodiment of the present invention.

FIG. 11 is a plan view of a pixel of a liquid crystal display device of one embodiment of the present invention.

FIGS. 12A to 12C are a plan view and cross-sectional views of a pixel of a liquid crystal display device of one embodiment of the present invention.

FIGS. 13A and 13B are cross-sectional views illustrating an example of a method for manufacturing a pixel of a liquid crystal display device of one embodiment of the present invention.

FIGS. 14A and 14B are cross-sectional views illustrating an example of a method for manufacturing a pixel of a liquid crystal display device of one embodiment of the present invention.

FIG. 15 is a cross-sectional view illustrating an example of a method for manufacturing a driver circuit of a liquid crystal display device of one embodiment of the present invention.

FIGS. 16A1, 16A2, and 16B are plan views and a cross-sectional view of a liquid crystal display device of one embodiment of the present invention.

FIGS. 17A to 17F are each an external view of an application example of a liquid crystal display device of one embodiment of the present invention.

### DETAILED DESCRIPTION OF THE INVENTION

Hereinafter, embodiments of the invention disclosed in this specification are described with reference to the accompanying drawings. Note that the invention disclosed in this specification is not limited to the following description, and it is easily understood by those skilled in the art that modes and details can be variously changed without departing from the spirit and the scope of the invention. Therefore, the invention disclosed in this specification is not construed as being limited to the description of the following embodiments. Note that the ordinal numbers such as “first” and “second” in this specification are used for convenience and do not denote the order of steps and the stacking order of layers. In addition, the ordinal numbers in this specification do not denote particular names which specify the present invention.

The descriptions in this embodiment can be combined with each other as appropriate.

### <Circuit Configuration of Pixel>

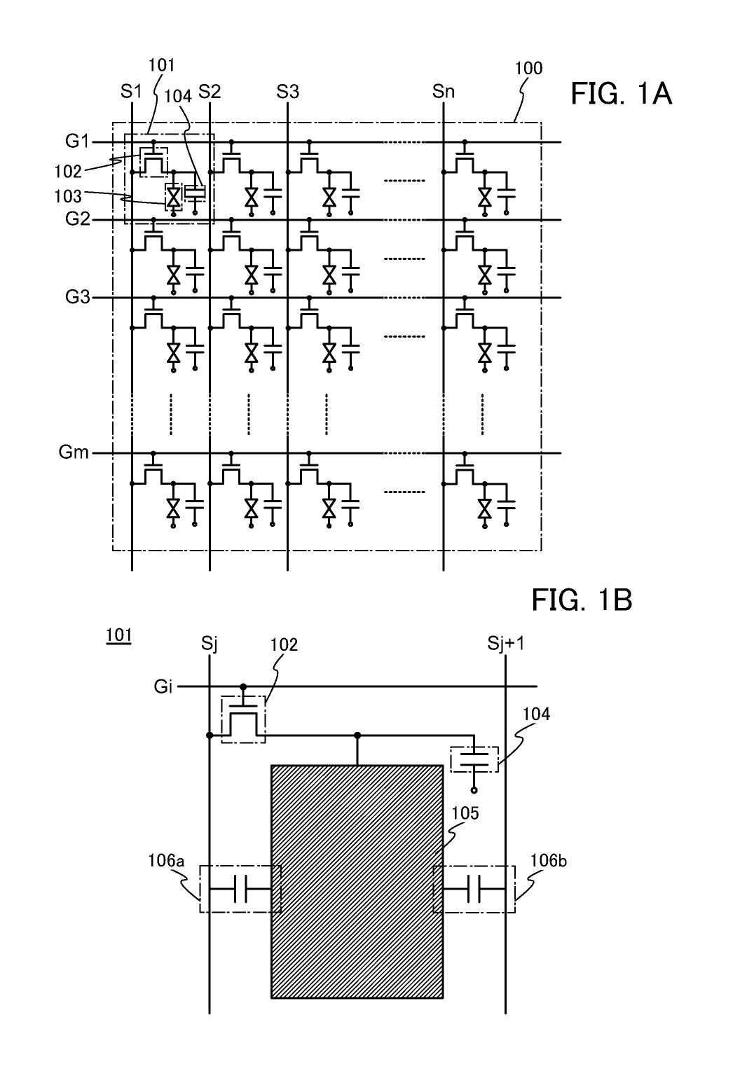

First, a circuit configuration of a pixel of a liquid crystal display device of one embodiment of the present invention is described with reference to FIGS. 1A and 1B, FIG. 2, FIGS. 3A to 3D, FIGS. 4A to 4D, FIGS. 5A and 5B, and FIG. 6.

FIG. 1A illustrates an equivalent circuit diagram of a pixel portion 100 of the liquid crystal display device of one embodiment of the present invention. As illustrated in FIG. 1A, the pixel portion 100 of the liquid crystal display device includes a plurality of gate lines G1 to Gm extending in a row direction, a plurality of source lines S1 to Sn extending in a column direction, and a plurality of pixels 101 which is electrically connected to the plurality of gate lines and the plurality of source lines and is provided in a matrix. Each of the pixels 101 is provided so as to be surrounded by two of the gate lines and two of the source lines. One of the pixels 101 which is connected to the gate line Gi (i is a natural number of 1 or more and (m−1) or less) and the source line Sj (j is a natural number of 1 or more and (n−1) or less) is provided so as to be surrounded by the gate line Gi, the gate line Gi+1, the source line Sj, and the source line Sj+1. Such a pixel 101 is denoted by the pixel 101 (Gi, Sj) in some cases.

The pixel 101 includes a transistor 102, a liquid crystal element 103, and a capacitor 104. A gate electrode of the transistor 102 is electrically connected to the gate line. One of a source electrode and a drain electrode of the transistor 102 is electrically connected to the source line. The other of the source electrode and the drain electrode of the transistor 102 is electrically connected to a pixel electrode of the liquid crystal element 103 and one electrode of the capacitor 104.

The transistor 102 serves as a switching transistor which determines whether to supply a potential corresponding to a video signal input from the source line (hereinafter, referred to as a video potential in some cases) to the pixel electrode of the liquid crystal element 103. Further, the liquid crystal element 103 includes at least the pixel electrode, a liquid crystal layer, and a counter electrode. A predetermined common potential is supplied to the counter electrode.

The capacitor 104 has a sufficiently lower capacitance value than a capacitor of a conventional liquid crystal display device including a silicon transistor. For example, in the case of a 26 μm×78 μm pixel having an aperture ratio of 60%, the capacitance value of the capacitor 104 can be smaller than or equal to 30 fF, preferably smaller than or equal to 15 fF. When the capacitance value of the capacitor 104 is set to such a small value, the area occupied by the capacitor 104 in the pixel 101 can be reduced; thus, the aperture ratio of the liquid crystal display device can be increased.

The transistor 102 has an extremely low off-state current. A semiconductor having a wider band gap and a lower intrinsic carrier density than silicon is used for a channel formation region of the transistor 102. As such a semiconductor, an oxide semiconductor typified by an In—Ga—Zn-based metal oxide is preferably used. In particular, a highly purified oxide semiconductor in which impurities serving as electron donors (donors) are reduced is preferably used. Specific examples of an oxide semiconductor which can be used for the transistor 102 and a method for highly purifying the oxide semiconductor are described later in detail.

The off-state current density of the transistor 102 in which the highly purified oxide semiconductor film is used as an active layer can be less than or equal to 1 aA/μm, preferably less than or equal to 100 zA/μm, more preferably lower than or equal to 100 yA/μm, more preferably less than or equal to 1 yA/μm. Accordingly, the transistor 102 including the highly purified oxide semiconductor film as an active layer has an extremely lower off-state current than a transistor including silicon having crystallinity.

### <Suppression of Leakage Current>

In order to display an image, in the pixel 101, it is needed to hold a potential corresponding to a video signal input to the pixel electrode through the transistor 102 and keep applying the potential to the liquid crystal layer of the liquid crystal element 103. While the potential corresponding to the video signal is held, the transistor 102 is turned off, and thus the pixel electrode is insulated from the source line and is in a floating state to hold charge. However, when the leakage current between the source and the drain of the transistor 102 is increased, the held charge moves from the pixel electrode to the source line, so that the potential of the pixel electrode is changed.

In a conventional liquid crystal display device, a silicon transistor having a large leakage current is used as its switching transistor; thus, the potential of the pixel electrode is held by providing a capacitor having a large capacitance value.

In contrast, in the liquid crystal display device of one embodiment of the present invention, a transistor which includes an oxide semiconductor and has an extremely low off-state current is used as the transistor 102; thus, even when the capacitance value of the capacitor 104 is set sufficiently small, the potential of the pixel electrode can be held for a long time.

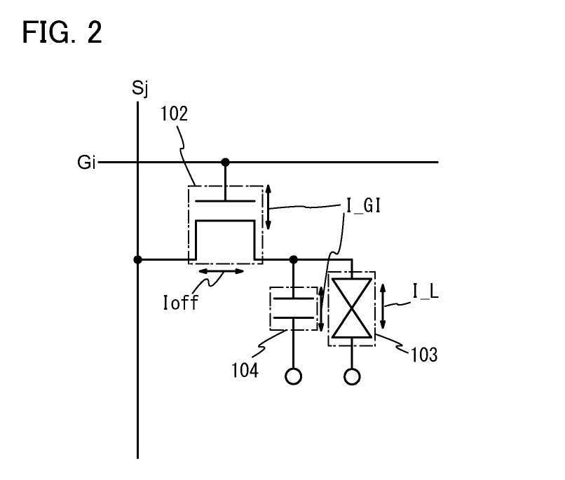

Here, leakage current which is generated in the transistor 102, the liquid crystal element 103, and the capacitor 104 illustrated in FIG. 2 when the potential of the pixel electrode is held is calculated, and the influence of the leakage current on holding the potential of the pixel electrode is described. Arrows illustrated in FIG. 2 indicate leakage current: off-state current Ioff between the source and the drain of the transistor 102, leakage current I_GI flowing through an insulating film serving as a gate insulating film of the transistor 102, and leakage current I_L flowing through the liquid crystal element 103.

In the case of a transistor including an oxide semiconductor film as an active layer, the off-state current Ioff is less than or equal to 100 zA/μm (1×10⁻¹⁹ A/μm) as described above. Further, the leakage current I_GI is less than or equal to 1 aA/μm (1×10⁻¹⁸ A/μm). The leakage current I_L is less than or equal to 1 aA/μm in twisted nematic (TN) liquid crystal, for example.

The video potential held in the pixel electrode of the pixel is changed by leakage current I leaked from the pixel. Here, V is the voltage which is the difference between the video potential and the changed video potential. The changing voltage V can be estimated from Formula 1. In Formula 1, T denotes holding time and C denotes the capacitance value of the entire pixel including capacitance of the capacitor.

V=(I×T)/C (1)

In Formula 1, the capacitance value C is 0.1 pF (1×10⁻¹³ F). At this time, when I=10 aA (1×10⁻¹⁷ A) and T= 1/60 s at a frame frequency of 60 Hz, the changing voltage V is approximately 10⁻⁶ V, and thus the change of gray levels due to leakage current does not become a big issue.

Assuming that the capacitance value C is 1 fF (1.0×10⁻¹⁵ A) in consideration of parasitic capacitance which is formed by the pixel electrode in the case where a capacitor is not provided intentionally, the changing voltage V is approximately 1×10⁻⁴ V, and thus the change of gray levels due to leakage current does not become a big issue.

In the case of a pixel in which a transistor including an amorphous silicon film as an active layer is used as a switching element, the off-state current I of the transistor is approximately 1×10⁻¹³ A. At this time, when the capacitance value C is approximately 1 fF (1.0×10⁻¹⁵ A), and I is 100 fA (1×10⁻¹³ A) and T is 1/60 s at a frame frequency of 60 Hz, the changing voltage V is approximately several volts, and thus the change of gray levels due to leakage current is not negligible.

The above shows that, even when the capacitance value of the capacitor 104 is set sufficiently low, the potential of the pixel electrode can be held for a long time with the use of a transistor which includes an oxide semiconductor and has an extremely low off-state current as the transistor 102.

### <Crosstalk>

However, the factor which changes the potential of the pixel electrode is not only the leakage current of a switching transistor. Here, a configuration of the pixel 101 (Gi, Sj) is illustrated in FIG. 1B. In FIG. 1B, a pixel electrode 105 is illustrated instead of the liquid crystal element 103. As described above, the pixel 101 (Gi, Sj) is positioned between the source line Sj and the source line Sj+1, and these source lines are positioned sufficiently close to the pixel electrode 105. Accordingly, first parasitic capacitance 106a is generated between the pixel electrode 105 and the source line Sj, and second parasitic capacitance 106b is generated between the pixel electrode 105 and the source line Sj+1.

While the potential corresponding to the video signal is held in the pixel electrode 105, the transistor 102 is off and the pixel electrode 105 is in a floating state. Thus, when the potential of the source line Sj or the source line Sj+1 is changed, the potential of the pixel electrode 105 is also changed due to capacitive coupling with the first parasitic capacitance 106a or the second parasitic capacitance 106b. Such potential change through parasitic capacitance is called crosstalk and causes a reduction in contrast of an image. For example, in the case where the liquid crystal element 103 is in a normally-white mode, the contrast of an image is reduced and the image is whitish.

The potentials of the source line Sj and the source line Sj+1 are changed at the time of input of the video signal. In the liquid crystal display device illustrated in FIG. 1A, the input of the video signals starts from the gate line G1, followed by the gate lines G2, G3, . . . and Gm in this order. When the gate line Gi+1 in the next row is selected and the video signals are input to the pixel 101 (Gi+1, Sj) and the pixel 101 (Gi+1, Sj+1), the potentials of the source line Sj and the source line Sj+1 are changed, so that the pixel 101 (Gi, Sj) in which the video signal is written to the pixel electrode 105 when the gate line Gi is selected is affected by crosstalk. When any of the gate lines Gi+2 to Gm is selected, the pixel is affected similarly by crosstalk.

In the liquid crystal display device, the video signals are input by a driving method, called inversion driving, in order to suppress degradation of a liquid crystal layer, called burn-in. The inversion driving is a driving method in which the polarities of the video signals are switched between a positive polarity and a negative polarity every frame period with the common potential applied to the counter electrode of the liquid crystal element 103 as a reference, and the video signals are supplied to the pixels. As the inversion driving, source line inversion driving, dot inversion driving, gate line inversion driving, frame inversion driving, and the like can be given, and they are different from one another in the method of input of the video signals. Hereinafter, a specific example of each inversion driving is described.

### <Source Line Inversion Driving>

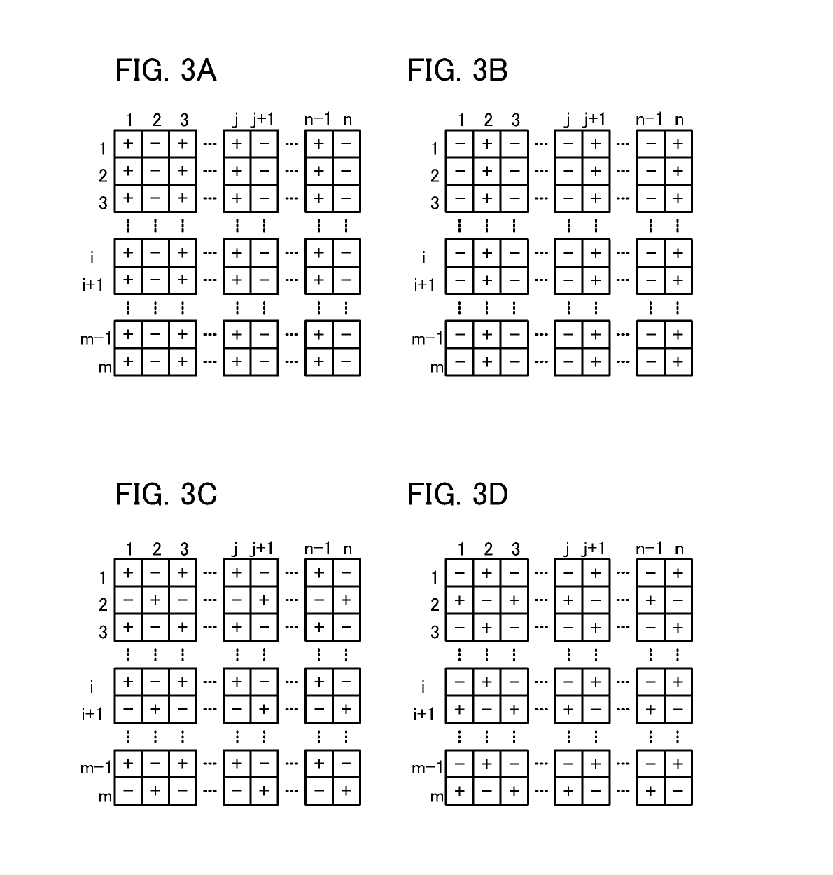

FIGS. 3A and 3B schematically show the polarities of the video signals input to the pixels at the time of source line inversion driving. In FIGS. 3A and 3B, the reference numerals in the column direction correspond to the reference numerals G1 to Gm of the gate lines, and the reference numerals in the row direction correspond to the reference numerals S1 to Sn of the source lines. The pixel denoted by the reference symbol “+” is a pixel to which the video signal having a positive polarity is input. The pixel denoted by the reference symbol “−” is a pixel to which the video signal having a negative polarity is input. FIG. 3A shows the polarities of the video signals input in one frame, and FIG. 3B shows the polarities of the video signals input in the next frame. In FIGS. 3A and 3B, the i-th row is an odd-numbered row, the j-th column is an odd-numbered column, the m-th row is an even-numbered row, and the n-th column is an even-numbered column.

In the source line inversion driving, as illustrated in FIG. 3A, in the same frame period, video signals having the same polarity are input to pixels connected to the same source line, and video signals having a different polarity are input to pixels connected to an adjacent source line. As illustrated in FIG. 3B, in the next frame, a video signal which has a polarity different from that in the previous frame is input to each pixel.

### <Dot Inversion Driving>

FIGS. 3C and 3D schematically show the polarities of the video signals input to the pixels at the time of dot inversion driving. The reference numerals in the column direction and the row direction and the reference symbols “+” and “−” in FIGS. 3C and 3D each have the same meaning as those in FIGS. 3A and 3B. The relation between FIGS. 3C and 3D is also the same as that between FIGS. 3A and 3B. In FIGS. 3C and 3D, the i-th row is an odd-numbered row, the j-th column is an odd-numbered column, the m-th row is an even-numbered row, and the n-th column is an even-numbered column.

In the dot inversion driving, as illustrated in FIG. 3C, in the same frame period, a video signal which has a polarity different from the polarity of a video signal input to an adjacent pixel in the row or column direction is input to each pixel. As illustrated in FIG. 3D, in the next frame, a video signal which has a polarity different from that in the previous frame is input to each pixel.

### <Gate Line Inversion Driving>

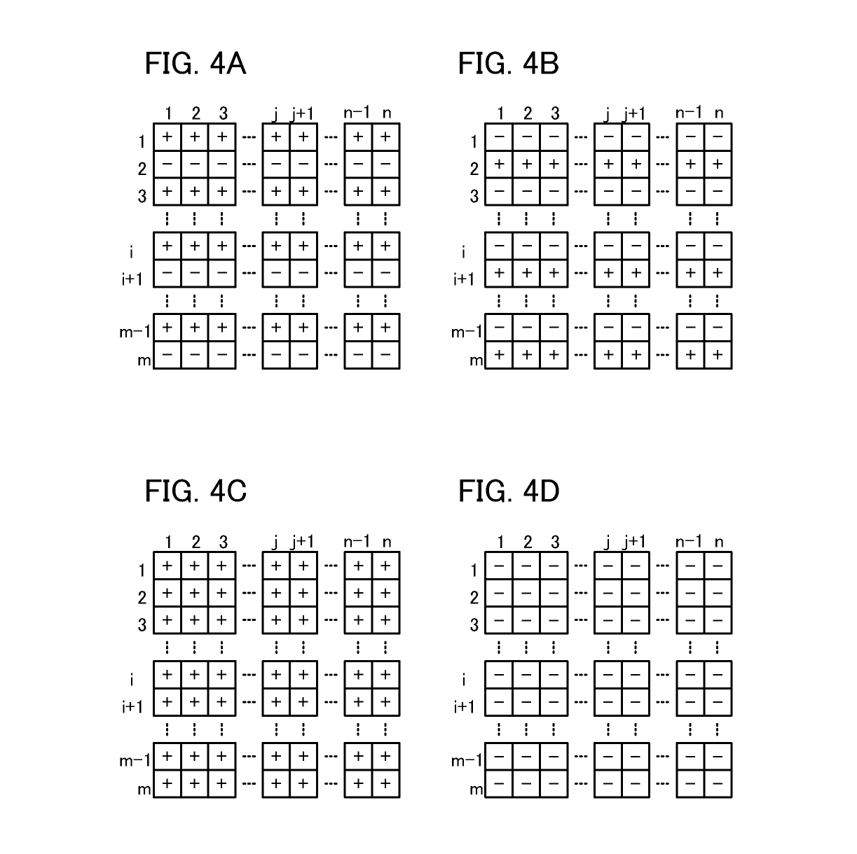

FIGS. 4A and 4B schematically show the polarities of the video signals input to the pixels at the time of gate line inversion driving. The reference numerals in the column direction and the row direction and the reference symbols “+” and “−” in FIGS. 4A and 4B each have the same meaning as those in FIGS. 3A and 3B. The relation between FIGS. 4A and 4B is also the same as that between FIGS. 3A and 3B. In FIGS. 4A and 4B, the i-th row is an odd-numbered row, the j-th column is an odd-numbered column, the m-th row is an even-numbered row, and the n-th column is an even-numbered column.

In the gate line inversion driving, as illustrated in FIG. 4A, in the same frame period, video signals having the same polarity are input to pixels connected to the same gate line, and video signals having a different polarity are input to pixels connected to an adjacent gate line. As illustrated in FIG. 4B, in the next frame, a video signal which has a polarity different from that in the previous frame is input to each pixel.

### <Frame Inversion Driving>

FIGS. 4C and 4D schematically show the polarities of the video signals input to the pixels at the time of frame inversion driving. The reference numerals in the column direction and the row direction and the reference symbols “+” and “−” in FIGS. 4C and 4D each have the same meaning as those in FIGS. 3A and 3B. The relation between FIGS. 4C and 4D is also the same as that between FIGS. 3A and 3B. In FIGS. 4C and 4D, the i-th row is an odd-numbered row, the j-th column is an odd-numbered column, the m-th row is an even-numbered row, and the n-th column is an even-numbered column.

As illustrated in FIG. 4C, in the frame inversion driving, the polarities of the video signals input to the pixels in one frame period are the same. As illustrated in FIG. 4D, the polarities of the video signals input to the pixels in the next frame are opposite to those in the one frame period.

### <Suppression of Crosstalk>

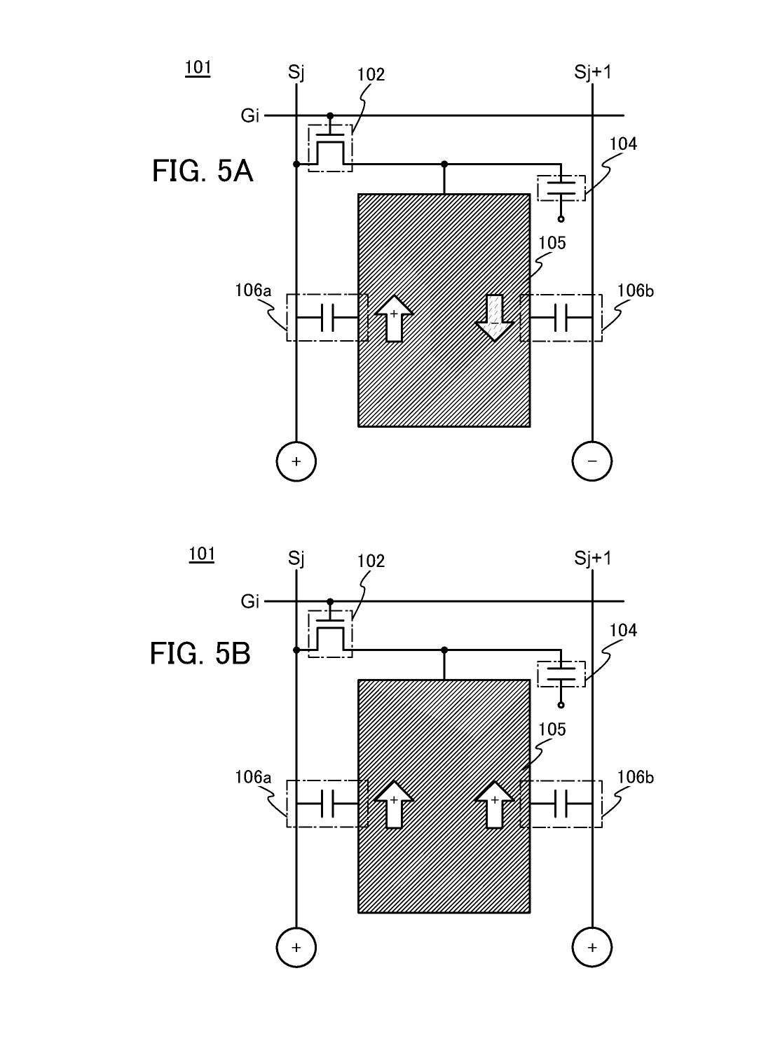

In an arbitrary pixel illustrated in FIGS. 3A to 3D and FIGS. 4A to 4D, in the source line inversion driving and the dot inversion driving, as illustrated in FIG. 5A, the polarity of the video signal input to the source line Sj (the positive polarity in FIG. 5A) is different from that of the video signal input to the source line Sj+1 (the negative polarity in FIG. 5A). In contrast, in the gate line inversion driving and the frame inversion driving, as illustrated in FIG. 5B, the polarity of the video signal input to the source line Sj (the positive polarity in FIG. 5B) is the same as that of the video signal input to the source line Sj+1 (the positive polarity in FIG. 5B).

As illustrated in FIG. 5B, in the case where the polarity of the potential supplied to the source line Sj is the same as that of the potential supplied to the source line Sj+1, crosstalk due to the first parasitic capacitance 106a and crosstalk due to the second parasitic capacitance 106b intensify each other, so that the potential of the pixel electrode 105 is greatly changed.

In contrast, as illustrated in FIG. 5A, in the case where the polarity of the potential supplied to the source line Sj is different from that of the potential supplied to the source line Sj+1, the crosstalk due to the first parasitic capacitance 106a and the crosstalk due to the second parasitic capacitance 106b cancel each other. In other words, as in the case of the source line inversion driving or the dot inversion driving, by making the polarities of the video signals supplied to the source line Sj different from those of the video signals supplied to the source line Sj+1, the potential change of the pixel electrode 105 due to the crosstalk can be reduced.

The contribution of the crosstalk due to the first parasitic capacitance 106a to the potential change of the pixel electrode 105 depends on the capacitance value of first parasitic capacitance 106a, and the contribution of the crosstalk due to the second parasitic capacitance 106b to the potential change of the pixel electrode 105 depends on the capacitance value of the second parasitic capacitance 106b. In order to suppress crosstalk by making the polarities of the video signals input to the source line Sj different from the polarities of the video signals input to the source line Sj+1, it is preferable that the capacitance value of the first parasitic capacitance 106a and the capacitance value of the second parasitic capacitance 106b be made approximately the same. Here, the expression “the capacitance value of the first parasitic capacitance 106a and the capacitance value of the second parasitic capacitance 106b are approximately the same” means that the difference between the capacitance value of the second parasitic capacitance 106b and the capacitance value of the first parasitic capacitance 106a is greater than or equal to −10% and smaller than or equal to 10%. Note that it is more preferable that the difference between the capacitance value of the second parasitic capacitance 106b and the capacitance value of the first parasitic capacitance 106a be greater than or equal to −5% and smaller than or equal to 5%.

### <Timing Chart of Source Line Inversion Driving>

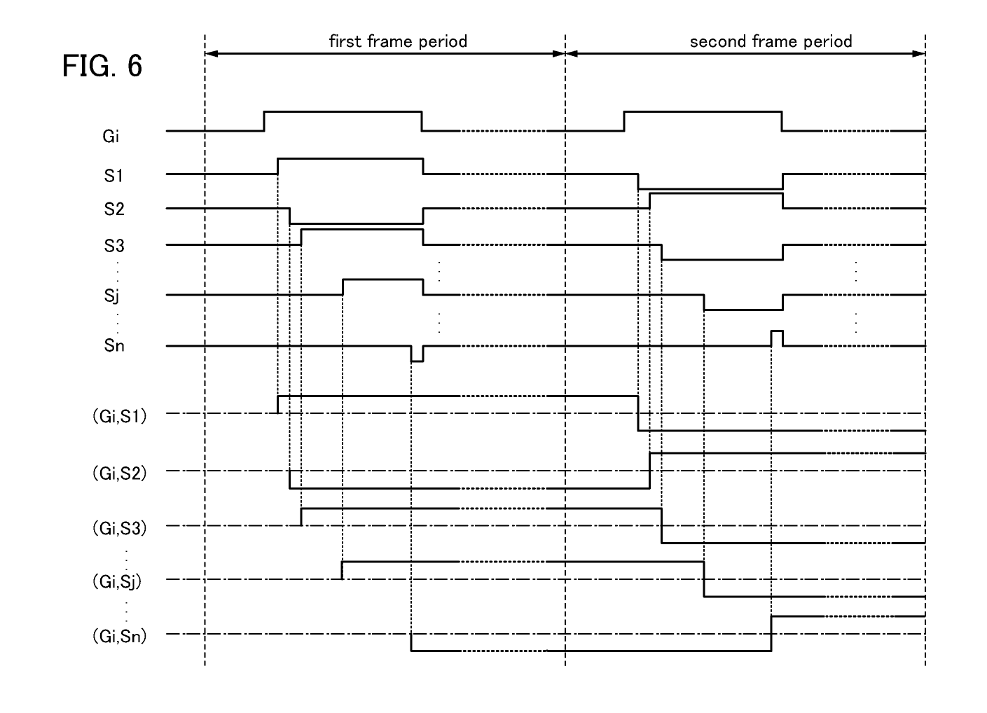

FIG. 6 is a timing chart of the case where the liquid crystal display device illustrated in FIG. 1A is operated by using the source line inversion driving. The timing chart in FIG. 6 shows the potential change of the gate line Gi, the source lines S1 to Sn, and the pixel electrodes 105 of the pixels 101 (Gi, S1) to (Gi, Sn) connected to the gate line Gi and the source lines S1 to Sn in the first frame period and the second frame period.

First, in the first frame period, the gate lines G1 to Gi−1 are sequentially selected, so that the video signals are input to the corresponding pixels. As illustrated in FIG. 6, the gate line Gi is selected and the transistor 102 connected to the gate line Gi is turned on. The video signals having a positive polarity are input to the source line S1, and a corresponding potential is input to the pixel electrode 105 of the pixel 101 (G1, S1). The video signals having a negative polarity are input to the source line S2, and a corresponding potential is input to the pixel electrode 105 of the pixel 101 (Gi, S2). Corresponding potentials are input to the pixel electrodes 105 while the polarities of the video signals are alternately changed from the source line S3 to the source line Sn in this order.

When the selection of the gate line Gi ends, in the gate lines Gi+1 to Gm, corresponding potentials are input to the pixel electrodes 105 similarly. The potentials of the source lines S1 to Sn adjacent to the pixel electrodes 105 of the pixels 101 (Gi, S1) to (Gi, Sn) in which the video signals are already held are changed in accordance with the video signals; however, since the source line inversion driving is performed, crosstalk is canceled each other as described above, so that the potentials of the pixel electrodes 105 are held.

In the second frame period, when the gate line Gi is selected, a video signal which has a polarity different from that in the first frame period is input to the source lines S1 to Sn, and the potentials held in the pixel electrodes 105 are rewritten to potentials corresponding to the new video signals. Similar operation is repeated in and after the third frame period.

The timing chart illustrated in FIG. 6 shows the case where the video signals are input to the source lines S1 to Sn sequentially; however, the video signals are not necessarily provided in this manner. The video signals may be input to all the source lines S1 to Sn at the same time. Alternatively, the video signals may be collectively input to a plurality of source lines.

In FIG. 6, a gate line is selected by progressive scan; however, a gate line may be selected by interlace scan.

In the inversion driving, the change in the potential supplied to the source line is increased at the time of changing the polarities of the video signals; thus, a potential difference between a source electrode and a drain electrode of the transistor 102 which serves as a switching element is increased. Accordingly, deterioration of characteristics of the transistor 102, such as a shift of threshold voltage, is easily caused. Furthermore, in order to maintain the voltage held in the liquid crystal element 103, the off-state current needs to be maintained low even when the potential difference between the source electrode and the drain electrode is large. In the liquid crystal display device of one embodiment of the present invention, an oxide semiconductor whose band gap is larger than that of silicon and whose intrinsic carrier density is lower than that of silicon is used for the transistor 102; therefore, the resistance of the transistor 102 to a high voltage can be increased and the off-state current can be made considerably low. Therefore, as compared to the case of using a transistor including a normal semiconductor material such as silicon, deterioration of the transistor 102 can be prevented and the voltage held in the liquid crystal element 103 can be maintained.

Note that the response time of a liquid crystal from application of voltage to saturation of the change in transmittance is generally about ten milliseconds. Thus, the slow response of the liquid crystal tends to be perceived as a blur of a moving image. As a countermeasure, overdriving may be employed in which the voltage applied to the liquid crystal element 103 is temporarily increased so that the orientation of a liquid crystal changes quickly. By overdriving, the response speed of the liquid crystal can be increased, a blur of a moving image can be prevented, and the quality of the moving image can be improved.

Further, if the transmittance of the liquid crystal keeps changing without reaching a constant value after the transistor 102 is turned off, the relative dielectric constant of the liquid crystal changes; accordingly, the voltage applied to the liquid crystal element easily changes. In particular, in the case where the capacitance value of the capacitor 104 is set sufficiently low, the change of the voltage applied to the liquid crystal element becomes remarkable. However, since overdriving can shorten response time, the transmittance of the liquid crystal can rapidly reach a constant value. Thus, even in the case where the capacitance value of the capacitor 104 is set sufficiently low, the change of the voltage applied to the liquid crystal element after the transistor 102 is turned off can be suppressed.

In the liquid crystal display device of one embodiment of the present invention, the transistor 102 which has an extremely low off-state current is used; thus, the holding time in the pixel electrode 105 can be extended and the writing frequency of the video signals can be reduced depending on the capacitance value of the capacitor 104. Accordingly, supply of a clock signal, a high potential power supply, or the like is stopped, so that the power consumption of the liquid crystal display device can be reduced. Further, stress of image rewriting affecting users' eyes is also reduced; thus, reduction of eyestrain of the users is expected. At this point, the liquid crystal display device is expected to have a great effect when used for a working display such as a personal computer.

The leakage current and crosstalk are suppressed in the above manner while the potential corresponding to the video signal is held in the pixel electrode, so that the image quality can be maintained even when the capacitance value of the capacitor is set small. When the capacitance value is set small, the area of the pixel occupied by the capacitor can be reduced and the aperture ratio of the pixel can be increased.

Thus, even in the case where the definition of the liquid crystal display device is increased and the area of each pixel is reduced, the aperture ratio of the pixels is sufficiently increased, and thus it is not needed to correct luminance by excessively increasing the amount of light of a backlight. As described above, an increase in power consumption of the backlight due to an increase in definition can be suppressed.

Thus, in the liquid crystal display device of one embodiment of the present invention, the definition can be increased and the power consumption can be reduced while the image quality is maintained.

### <Specific Structure of Pixel>

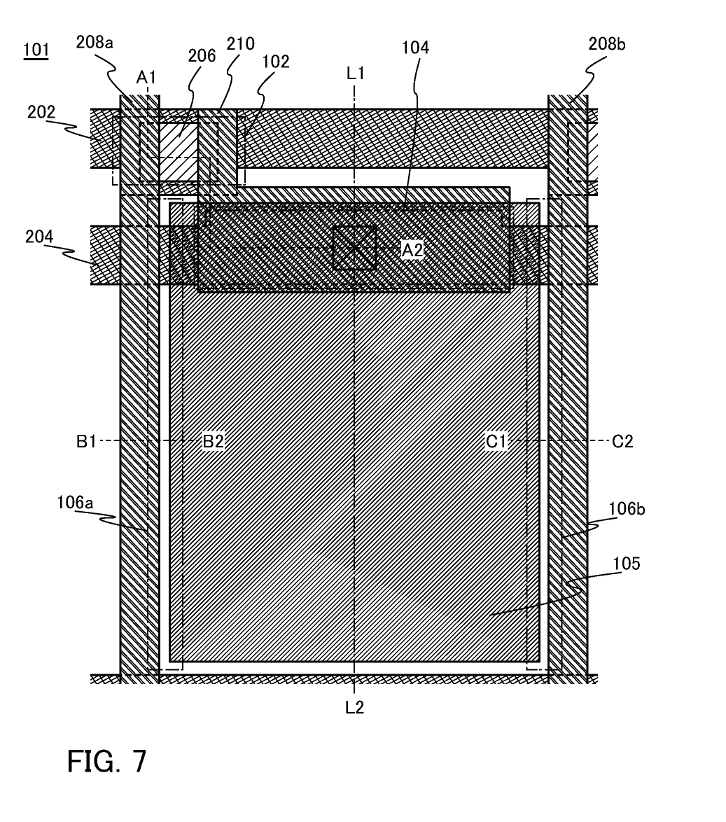

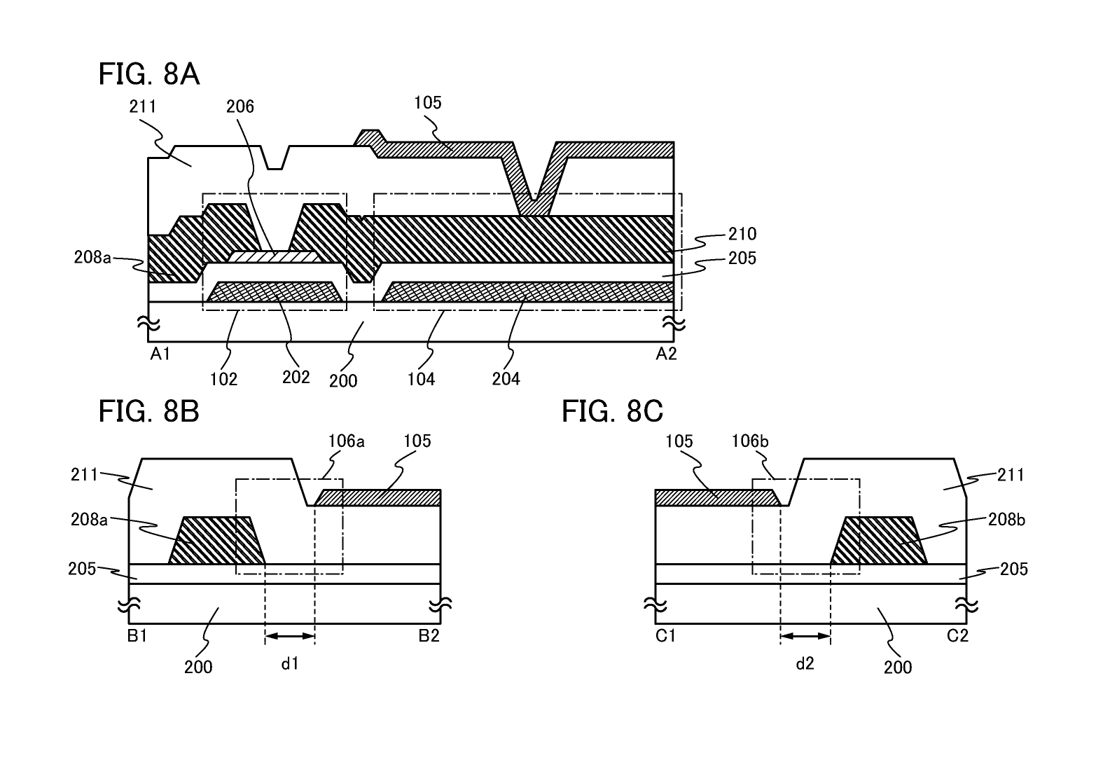

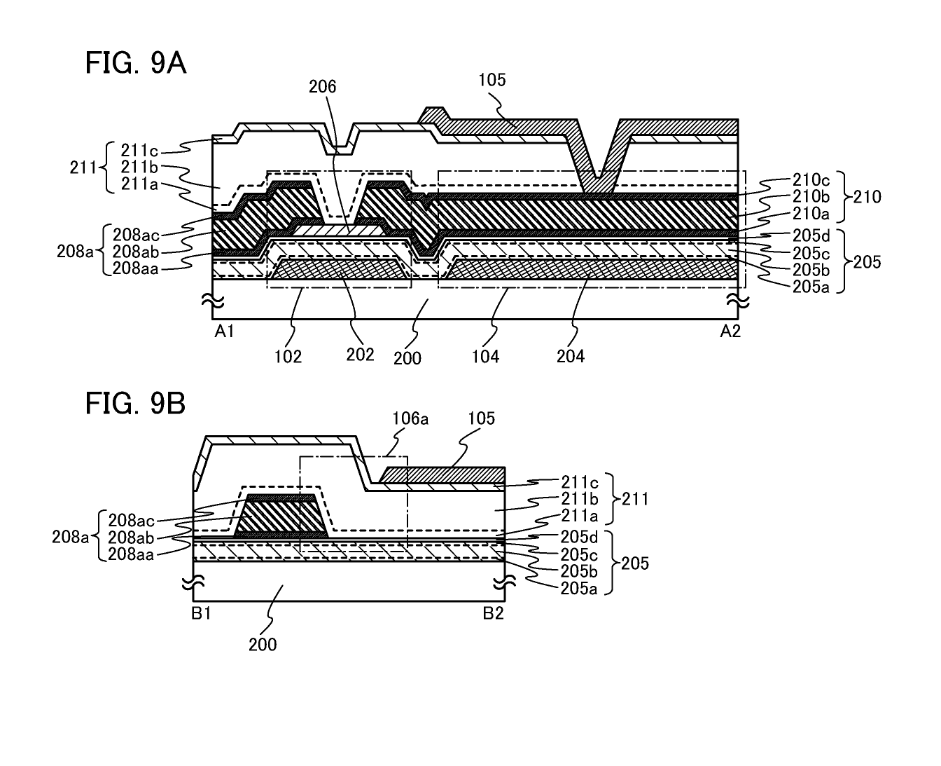

Next, specific structures of a pixel of a liquid crystal display device of one embodiment in the present invention are described with reference to FIG. 7, FIG. 8A to 8C, FIGS. 9A and 9B, FIGS. 10A and 10B, FIG. 11, and FIG. 12A to 12C.

FIG. 7 illustrates an example of a plan view of a liquid crystal device of one embodiment of the present invention. FIG. 8A is a cross-sectional view taken along dotted line A1-A2 in FIG. 7. FIG. 8B is a cross-sectional view taken along dotted line B1-B2 in FIG. 7. FIG. 8C is a cross-sectional view taken along dotted line C1-C2 in FIG. 7.

As illustrated in FIG. 7, the pixel 101 is formed in a region surrounded by a gate line 202 extending in the row direction, a gate line of an adjacent pixel in the row direction, a source line 208a extending in the column direction, and a source line 208b of an adjacent pixel in the column direction. The transistor 102, the capacitor 104, and the pixel electrode 105 included in a liquid crystal element are formed in the region.

In the liquid crystal display device of one embodiment of the present invention, 200 or more of the pixels 101, preferably 300 or more of the pixels 101, are formed in each inch. In other words, 200 or more of source or gate lines, preferably 300 or more of source or gate lines, are formed in each inch. The pixels are formed to have such a density, so that a high-definition liquid crystal display device can be provided.

As illustrated in FIG. 7 and FIG. 8A, the transistor 102 is formed over a substrate 200, and includes a gate electrode integrated with the gate line 202, a gate insulating film 205 over the gate electrode, an oxide semiconductor film 206 over the gate insulating film 205 to overlap with the gate electrode, and the source line 208a and a conductive film 210 in contact with the oxide semiconductor film 206. Part of the source line 208a serves as one of source and drain electrodes of the transistor 102, and the conductive film 210 serves as the other of the source and drain electrodes of the transistor 102. A protective insulating film 211 is formed over the oxide semiconductor film 206, the source line 208a, and the conductive film 210. The pixel electrode 105 connected to the conductive film 210 through an opening is formed over the protective insulating film 211.

The transistor 102 in the liquid crystal display device of one embodiment of the present invention is a bottom-gate channel-etched transistor; however, the present invention is not limited to this, and for example, the transistor 102 may be a top-gate transistor or a bottom-gate channel-protective transistor.

As illustrated in FIG. 7 and FIG. 8A, the capacitor 104 is formed in a region over the substrate 200. In the region, a capacitor line 204 which extends in the column direction and is parallel to the gate line 202, the gate insulating film 205, and the conductive film 210 overlap with one another. As described above, the capacitance value of the capacitor 104 can be set sufficiently small, and for example, the capacitance value can be greater than or equal to 0 fF and smaller than or equal to 30 fF, preferably greater than or equal to 0 fF and smaller than or equal to 15 fF. Depending on the set capacitance value, the areas of the capacitor line 204 and the conductive film 210 are determined, so that the area of the pixel 101 occupied by the capacitor 104 can be reduced and the aperture ratio of the liquid crystal display device can be increased. For example, the aperture ratio is preferably greater than or equal to 60%.

In the liquid crystal display device of one embodiment of the present invention, the capacitor 104 includes the capacitor line 204, the gate insulating film 205, and the conductive film 210, but the present invention is not limited thereto. For example, the capacitor 104 may include the capacitor line 204, the gate insulating film 205 and/or the protective insulating film 211, and the pixel electrode 105.

As illustrated in FIG. 7, FIG. 8B, and FIG. 8C, the source line 208a and the pixel electrode 105 form the first parasitic capacitance 106a by using the protective insulating film 211 as a dielectric, and the source line 208b and the pixel electrode 105 form the second parasitic capacitance 106b by using the protective insulating film 211 as a dielectric. As described above, in order to suppress the crosstalk due to the first parasitic capacitance 106a and the second parasitic capacitance 106b, it is preferable that the capacitance value of the first parasitic capacitance 106a and the capacitance value of the second parasitic capacitance 106b be made approximately the same.

Here, the first parasitic capacitance 106a is formed mainly between the left end of the pixel electrode 105 (the end portion of the pixel electrode 105 on the source line 208a side) and the source line 208a. The second parasitic capacitance 106b is formed mainly between the right end of the pixel electrode 105 (the end portion of the pixel electrode 105 on the source line 208b side) and the source line 208b. Thus, the capacitance values of the first parasitic capacitance 106a and the second parasitic capacitance 106b can be set relatively easily by adjusting the planar shape of the pixel electrode 105.

In order to make the capacitance value of the first parasitic capacitance 106a and the capacitance value of the second parasitic capacitance 106b approximately the same, the pixel electrode 105 preferably has a planar shape illustrated in FIG. 7, which is almost symmetrical about a bisector L1-L2 of the source line 208a and the source line 208b. With the pixel electrode 105 having such a planar shape, as illustrated in FIGS. 8B and 8C, a distance d1 between the left end of the pixel electrode 105 and the source line 208a is approximately the same as a distance d2 between the right end of the pixel electrode 105 and the source line 208b; thus, the capacitance value of the first parasitic capacitance 106a and the capacitance value of the second parasitic capacitance 106b can be approximately the same.

The bisector L1-L2 is a line on which a distance from an arbitrary point to the source line 208a is the same as a distance from the arbitrary point to the source line 208b. Further, the expression “the planar shape of the pixel electrode is almost symmetrical about the bisector” means that when the pixel electrode 105 is folded along the bisector L1-L2 so as to be divided into two: a left half and a right half, the ratio of the area of a region where the left half and the right half do not overlap with each other to the area of a region where the left half and the right half overlap with each other is smaller than or equal to 10%.

Further, in the planar shape of the pixel electrode, in general, the length of the left end of the pixel electrode is not greatly different from that of the right end of the pixel electrode. Therefore, the difference between the distance d1 and the distance d2 is preferably greater than or equal to −10% and smaller than or equal to 10%, more preferably greater than or equal to −5% and smaller than or equal to 5%.

The planar shape of the pixel electrode 105 is determined as described above, so that the capacitance value of the first parasitic capacitance 106a and the capacitance value of the second parasitic capacitance 106b can be approximately the same, and thus the crosstalk due to the first parasitic capacitance 106a and the crosstalk due to the second parasitic capacitance 106b can cancel each other. Accordingly, in the liquid crystal display device of one embodiment of the present invention, even in the case where the definition is increased and the power consumption is reduced simultaneously, the image quality can be maintained.

Each component of the pixel portion of the liquid crystal display device is described below in detail. The thickness of each component or the like may be determined as appropriate in accordance with the specifications of the liquid crystal display device, and is not necessarily limited to the description below.

### <Substrate>

As the substrate 200, a substrate having a light-transmitting property is preferable, and a glass substrate, a ceramic substrate, a plastic substrate, or the like can be used. For a plastic substrate, a fiberglass-reinforced plastics (FRP) plate, a polyvinyl fluoride (PVF) film, a polyester film, or an acrylic resin film can be used.

In the case where a flexible substrate is used as the substrate 200, there is also a method in which a transistor or the like is formed over a non-flexible substrate, and then is separated from the non-flexible substrate and transferred to the substrate 200 which is a flexible substrate. In that case, a separation layer is preferably provided between the non-flexible substrate and the transistor.

### <Gate Line>

The gate line 202 may be formed of a single layer or a stacked layer of a conductive film containing one or more kinds of aluminum, titanium, chromium, cobalt, nickel, copper, yttrium, zirconium, molybdenum, ruthenium, silver, tantalum, and tungsten. The capacitor line 204 which is formed in the same layer as the gate line 202 may also be formed using a material similar to that of the gate line 202.

In FIG. 7, the oxide semiconductor film 206 is provided on the inner side of the gate line 202. Thus, the oxide semiconductor film 206 is not irradiated with light entering from the substrate 200 side, so that the generation of carriers in the oxide semiconductor film 206 by the light can be suppressed. Note that the planar shape of the gate line 202 is not limited thereto.

When the gate line 202 is formed as described above, a region where the gate line 202 overlaps with the conductive film 210 can also be increased. When the region where the gate line 202 overlaps with the conductive film 210 serving as the other of the source and drain electrodes of the transistor 102 is increased and the parasitic capacitance of the region is sufficiently increased, the effect of the crosstalk due to the first parasitic capacitance 106a and the crosstalk due to the second parasitic capacitance 106b can be reduced.

### <Gate Insulating Film>

The gate insulating film 205 may be formed of a single layer or a stacked layer using an insulating film containing one or more kinds of aluminum oxide, magnesium oxide, silicon oxide, silicon oxynitride, silicon nitride oxide, silicon nitride, gallium oxide, germanium oxide, yttrium oxide, zirconium oxide, lanthanum oxide, neodymium oxide, hafnium oxide, and tantalum oxide. Note that in this specification and the like, “silicon oxynitride” contains more oxygen than nitrogen, and “silicon nitride oxide” contains more nitrogen than oxygen.

The gate insulating film 205 may be, for example, a multi-layer film including a silicon nitride layer as a first layer and a silicon oxide layer as a second layer. In this case, a silicon oxynitride layer may be used instead of the silicon oxide layer. Further, a silicon nitride oxide layer may be used instead of the silicon nitride layer. As the silicon oxide layer or the silicon oxynitride layer, a silicon oxide layer or a silicon oxynitride layer with a low defect density is preferably used. Specifically, the silicon oxide layer or the silicon oxynitride layer whose spin density attributed to a signal with a g-factor of 2.001 in electron spin resonance (ESR) spectroscopy is 3×10¹⁷ spins/cm³ or less, preferably 5×10¹⁶ spins/cm³ or less is used. As the silicon oxide layer or the silicon oxynitride layer, a layer which contains excess oxygen and from which oxygen is released by heat treatment or the like is preferably used. Here, the layer from which oxygen is released by heat treatment may release oxygen, the amount of which is greater than or equal to 1×10¹⁸ atoms/cm³, greater than or equal to 1×10¹⁹ atoms/cm³, or greater than or equal to 1×10²⁰ atoms/cm³ in TDS analysis (converted into the number of oxygen atoms). As the silicon oxide layer containing excess oxygen, a silicon oxide layer represented by SiOₓ (x>2) may be used. In the silicon oxide layer represented by SiOₓ (x>2), the number of oxygen atoms per unit volume is more than twice the number of silicon atoms per unit volume. The number of silicon atoms and the number of oxygen atoms per unit volume are measured by Rutherford backscattering spectrometry (RBS).

As the silicon nitride layer used as the first layer, a silicon nitride layer from which hydrogen and ammonia are less likely to be released is preferably used. The amount of released hydrogen and ammonia is preferably measured by thermal desorption spectroscopy (TDS) analysis.

As the silicon nitride layer used as the first layer, a plurality of nitride layers containing different amounts of hydrogen and ammonia may be stacked. For example, as illustrated in FIGS. 9A and 9B, the gate insulating film 205 may include the first silicon nitride layer 205a, the second silicon nitride layer 205b over the first silicon nitride layer 205a, the third silicon nitride layer 205c over the second silicon nitride layer 205b, and the silicon oxynitride layer 205d over the third silicon nitride layer 205c. FIGS. 9A and 9B show a specific example of a stacked structure of each of the gate insulating film 205, the source line 208a, the conductive film 210, and the protective insulating film 211 of the cross-sectional views illustrated in FIGS. 8A and 8B. The conductive film 210 and the protective insulating film 211 are sequentially described below. For a specific example of a stacked structure illustrated in FIG. 8C, a description of FIG. 9B can be referred to.

The hydrogen content and the ammonia content in the first silicon nitride layer 205a are smaller than those in the second silicon nitride layer 205b. When the ammonia content in the first silicon nitride layer 205a is reduced, metal in the gate line 202 is prevented from reacting with ammonia to be diffused into the gate insulating film 205. The entry of impurities serving as electron donors (donors) in an oxide semiconductor, such as hydrogen and a hydrogen compound (e.g., water), from the substrate 200 can be reduced.

The second silicon nitride layer 205b preferably has a greater thickness than the first silicon nitride layer 205a and the third silicon nitride layer 205c, and in the second silicon nitride layer 205b, the number of defects is preferably reduced. For example, the thickness is preferably greater than or equal to 250 nm and less than or equal to 400 nm Further, the second silicon nitride layer 205b preferably has a spin density attributed to a signal with a g-factor of 2.003 in ESR of 1×10¹⁷ spins/cm³ or less, more preferably 5×10¹⁶ spins/cm³ or less. With the use of such a silicon nitride layer which has a great thickness and in which the number of defects is reduced as the second silicon nitride layer 205b, resistance to ESD of the gate insulating film 205 can be greatly improved.

As in the first silicon nitride layer 205a, the hydrogen content and the ammonia content in the third silicon nitride layer 205c are also small. When the hydrogen content in the third silicon nitride layer 205c positioned close to the oxide semiconductor film 206 is reduced, entry of impurities from the third silicon nitride layer 205c and the second silicon nitride layer 205b into the oxide semiconductor film 206 can be reduced. Here, the impurities are impurities, such as hydrogen and a hydrogen compound (e.g., water), serving as donors in the oxide semiconductor.

As the silicon oxynitride layer 205d, a silicon oxynitride layer which contains excess oxygen and from which oxygen is released by the heat treatment or the like is preferably used. The use of such a layer enables oxygen to be supplied to the oxide semiconductor film 206, so that oxygen is prevented from being desorbed from the oxide semiconductor film 206 and oxygen vacancies can be compensated.

In the case where the gate insulating film 205 is formed as described above, for example, the thickness of the first silicon nitride layer 205a may be 50 nm, the thickness of the second silicon nitride layer 205b may be 200 nm, the thickness of the third silicon nitride layer 205c may be 50 nm, and the thickness of the silicon oxynitride layer 205d may be 50 nm.

The thickness of the gate insulating film 205 is not necessarily uniform. For example, in the gate insulating film 205, a region overlapping with the oxide semiconductor film 206 may be greater than a region not overlapping with the oxide semiconductor film 206.

A base insulating film may be provided between the substrate 200, and the gate line 202 and the capacitor line 204. The base insulating film may be formed using a material similar to that of the gate insulating film.

### <Oxide Semiconductor Film>

As described above, an oxide semiconductor used for the oxide semiconductor film 206 preferably has a wider band gap than silicon. For example, an oxide semiconductor having a band gap of 2 eV or larger, preferably 2.5 eV or larger, further preferably 3 eV or larger is used.

An oxide semiconductor containing at least indium (In) or zinc (Zn) is preferably used for the oxide semiconductor film 206. Alternatively, the oxide semiconductor film 206 preferably contains both In and Zn. In order to reduce variations in electrical characteristics of the transistors including the oxide semiconductor, the oxide semiconductor preferably contains one or more stabilizers below in addition to In and Zn.

As a stabilizer, gallium (Ga), tin (Sn), hafnium (Hf), aluminum (Al), zirconium (Zr), and the like can be given. As another stabilizer, lanthanoids such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), and the like can be given.

As the oxide semiconductor, for example, any of the following can be used: indium oxide; tin oxide; zinc oxide; an oxide containing two kinds of metals, such as an In—Zn-based oxide, an Sn—Zn-based oxide, an Al—Zn-based oxide, a Zn—Mg-based oxide, an Sn—Mg-based oxide, an In—Mg-based oxide, or an In—Ga-based oxide; an oxide containing three kinds of metals, such as an In—Ga—Zn-based oxide (also referred to as IGZO), an In—Al—Zn-based oxide, an In—Sn—Zn-based oxide, an Sn—Ga—Zn-based oxide, an Al—Ga—Zn-based oxide, an Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, or an In—Lu—Zn-based oxide; an oxide containing four kinds of metals, such as an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

Here, an “In—Ga—Zn-based oxide” means an oxide containing In, Ga, and Zn as its main components and there is no particular limitation on the ratio of In:Ga:Zn. The In—Ga—Zn-based oxide may contain a metal element other than the In, Ga, and Zn.

For example, the oxide semiconductor film may be formed by a sputtering method using a target having an atomic ratio of In:Ga:Zn=1:1:1, a target having an atomic ratio of In:Ga:Zn=3:1:2, or the like.

Note that without limitation to the materials given above, a material with an appropriate atomic ratio depending on semiconductor characteristics and electrical characteristics (field-effect mobility, threshold voltage, and the like) may be used. In order to obtain necessary semiconductor characteristics, it is preferable that the carrier density, the impurity concentration, the defect density, the atomic ratio of a metal element to oxygen, the interatomic distance, the density, and the like be set to be appropriate.

Further, the oxide semiconductor used for the oxide semiconductor film 206 preferably has a lower intrinsic carrier density than silicon. As such an oxide semiconductor, an oxide semiconductor highly purified by reducing impurities serving as electron donors (donors) in the oxide semiconductor is preferable. Specifically, the carrier density of the oxide semiconductor film 206 is smaller than 1×10¹⁷/cm³, smaller than 1×10¹⁵/cm³, or smaller than 1×10¹³/cm³. In the oxide semiconductor film 206, hydrogen, nitrogen, carbon, silicon, and metal elements other than main components are impurities.

In particular, when silicon is contained in the oxide semiconductor film 206 at a high concentration, an impurity level caused by silicon is formed in the oxide semiconductor film 206. The impurity level serves as a trap level, and may degrade electrical characteristics of a transistor. In order to reduce degradation of electrical characteristics of the transistor, the silicon concentration of the oxide semiconductor film 206 is smaller than 1×10¹⁹ atoms/cm³, preferably smaller than 5×10¹⁸ atoms/cm³, more preferably smaller than 1×10¹⁸ atoms/cm³.

Further, in the oxide semiconductor film 206, hydrogen and nitrogen generate a donor level, and increase the carrier density. In order to make the oxide semiconductor film 206 intrinsic or substantially intrinsic, the concentration of hydrogen in the oxide semiconductor film 206, which is measured by SIMS, is lower than 2×10²⁰ atoms/cm³, preferably lower than or equal to 5×10¹⁹ atoms/cm³, more preferably lower than or equal to 1×10¹⁹ atoms/cm³, still more preferably lower than or equal to 5×10¹⁸ atoms/cm³. The concentration of nitrogen, which is measured by SIMS, can be set to be lower than 5×10¹⁹ atoms/cm³, preferably lower than or equal to 5×10¹⁸ atoms/cm³, more preferably lower than or equal to 1×10¹⁸ atoms/cm³, further preferably lower than or equal to 5×10¹⁷ atoms/cm³.

Specifically, various experiments can actually prove low off current of the transistor including the highly purified oxide semiconductor film as an active layer. For example, even with an element with a channel width of 1×10⁶ μm and a channel length of 10 μm, in a range of from 1 V to 10 V of voltage (drain voltage) between a source electrode and a drain electrode, it is possible that off current (which is drain current in the case where voltage between a gate electrode and the source electrode is 0 V or less) is less than or equal to the measurement limit of a semiconductor parameter analyzer, that is, less than or equal to 1×10⁻¹³ A. In this case, it can be found that an off current density corresponding to a value obtained by dividing the off current by the channel width of the transistor is less than or equal to 100 zA/μm. In addition, a capacitor and a transistor were connected to each other and an off current density was measured by using a circuit in which electric charge flowing into or from the capacitor was controlled by the transistor. In the measurement, the highly purified oxide semiconductor film was used as a channel formation region in the transistor, and the off current density of the transistor was measured from change in the amount of electric charge of the capacitor per unit time. As a result, it was found that in the case where the voltage between the source electrode and the drain electrode of the transistor was 3V, a lower off current density of several tens yoctoampere per micrometer (yA/μm) was able to be obtained. Therefore, in the semiconductor device of one embodiment of the present invention, the off current density of the transistor including the highly purified oxide semiconductor film as an active layer can be less than or equal to 100 yA/μm, preferably less than or equal to 10 yA/μm, or more preferably less than or equal to 1 yA/μm, depending on the voltage between the source electrode and drain electrode. Accordingly, the transistor including the highly purified oxide semiconductor film as an active layer has much lower off current than a transistor including silicon having crystallinity.

### <CAAC-OS>

As the oxide semiconductor used for the oxide semiconductor film 206, oxide semiconductors having various crystal states, such as an amorphous oxide semiconductor, a single crystal oxide semiconductor, and a polycrystalline oxide semiconductor, can be used. As the oxide semiconductor, a c-axis aligned crystalline oxide semiconductor (CAAC-OS) film is preferably used.

The CAAC-OS film is one of oxide semiconductor films having a plurality of c-axis aligned crystal parts.

In a transmission electron microscope (TEM) image of the CAAC-OS film, a boundary between crystal parts, that is, a grain boundary is not clearly observed. Thus, in the CAAC-OS film, a reduction in electron mobility due to the grain boundary is less likely to occur.

According to the TEM image of the CAAC-OS film observed in a direction substantially parallel to a sample surface (cross-sectional TEM image), metal atoms are arranged in a layered manner in the crystal parts. Each metal atom layer has a morphology reflected by a surface over which the CAAC-OS film is formed (also referred to as a formation surface) or a top surface of the CAAC-OS film, and is arranged in parallel to the formation surface or the top surface of the CAAC-OS film.

On the other hand, according to the TEM image of the CAAC-OS film observed in a direction substantially perpendicular to the sample surface (plan TEM image), metal atoms are arranged in a triangular or hexagonal configuration in the crystal parts. However, there is no regularity of arrangement of metal atoms between different crystal parts.

From the results of the cross-sectional TEM image and the plan TEM image, alignment is found in the crystal parts in the CAAC-OS film.

Most of the crystal parts included in the CAAC-OS film each fit inside a cube whose one side is less than 100 nm Thus, there is a case where a crystal part included in the CAAC-OS film fits a cube whose one side is less than 10 nm, less than 5 nm, or less than 3 nm Note that when a plurality of crystal parts included in the CAAC-OS film are connected to each other, one large crystal region is formed in some cases. For example, a crystal region with an area of 2500 nm² or more, 5 μm² or more, or 1000 μm² or more is observed in some cases in the plan TEM image.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

On the other hand, when the CAAC-OS film is analyzed by an in-plane method in which an X-ray enters a sample in a direction substantially perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when φ scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned with a direction parallel to a normal vector of a formation surface or a normal vector of a top surface of the CAAC-OS film. Thus, for example, in the case where a shape of the CAAC-OS film is changed by etching or the like, the c-axis might not be necessarily parallel to a normal vector of a formation surface or a normal vector of a top surface of the CAAC-OS film.

Further, distribution of c-axis aligned crystal parts in the CAAC-OS film is not necessarily uniform. For example, in the case where crystal growth leading to the crystal parts of the CAAC-OS film occurs from the vicinity of the top surface of the CAAC-OS film, the proportion of the c-axis aligned crystal parts in the vicinity of the top surface is higher than that in the vicinity of the formation surface in some cases. Further, when an impurity is added to the CAAC-OS film, a region to which the impurity is added is altered, and the proportion of the c-axis aligned crystal parts in the CAAC-OS film varies depending on regions, in some cases.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in part of the CAAC-OS film. It is preferable that in the CAAC-OS film, a peak of 2θ appear at around 31° and a peak of 2θ do not appear at around 36°.

The CAAC-OS film is an oxide semiconductor film having low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Further, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein.

The state in which impurity concentration is low and density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Thus, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has little variation in electrical characteristics and high reliability. Electric charge trapped by the carrier traps in the oxide semiconductor film takes a long time to be released, and might behave like fixed charge. Thus, the transistor which includes the oxide semiconductor film having high impurity concentration and a high density of defect states has unstable electrical characteristics in some cases.

With the use of the CAAC-OS film in a transistor, variation in the electrical characteristics of the transistor due to irradiation with visible light or ultraviolet light is small.

### <Stacked-Layer Structure>

The oxide semiconductor film 206 may have a stacked-layer structure in which a plurality of oxide semiconductor layers having different compositions or different atomic ratios are stacked. Alternatively, oxide semiconductor layers having different crystallinities may be stacked each other. That is, the oxide semiconductor film 206 may be formed using a combination of any of a single crystal oxide semiconductor, a polycrystalline oxide semiconductor, a microcrystalline oxide semiconductor, an amorphous oxide semiconductor, and a CAAC-OS as appropriate. Here, by making the constituent elements of the stacked oxide semiconductor layers the same each other, the defect states at the interface between each oxide semiconductor layer are reduced, and the amount of change in the threshold voltage of the transistor including the oxide semiconductor film due to change over time or a reliability test can be reduced.

For example, the oxide semiconductor film 206 has a two-layer structure in which a second oxide semiconductor layer is formed over a first oxide semiconductor layer. At this time, the atomic ratio of In to Ga in one of the first oxide semiconductor layer and the second oxide semiconductor layer which is closer to the gate electrode (the oxide semiconductor film on the channel side) satisfies the relation In<Ga and the atomic ratio of In to Ga in the other which is on the back channel side satisfies the relation In≧Ga, whereby the amount of change in the threshold voltage of a transistor due to change over time or a reliability test can be reduced.

As an oxide semiconductor having such an atomic ratio, for example, a structure where the first oxide semiconductor layer has an atomic ratio of In:Ga:Zn=1:3:2 and the second oxide semiconductor layer has an atomic ratio of In:Ga:Zn=1:1:1 can be given. Note that the atomic ratio of each oxide semiconductor layer varies within a range of ±20% of the above atomic ratio as an error. Here, the second oxide semiconductor layer which can be a channel formation region is preferably a CAAC-OS film.

Further, a structure where a third oxide semiconductor layer is provided over the second oxide semiconductor layer may be used. For example, a structure where the first oxide semiconductor layer has an atomic ratio of In:Ga:Zn=1:3:2, the second oxide semiconductor layer has an atomic ratio of In:Ga:Zn=1:1:1, and the third oxide semiconductor layer has an atomic ratio of In:Ga:Zn=1:3:2 can be given. Note that the atomic ratio of each oxide semiconductor layer varies within a range of ±20% of the above atomic ratio as an error. Here, the second oxide semiconductor layer which can be a channel formation region is preferably a CAAC-OS film. With such a three-layer stacked structure, oxygen can be diffused between the first to third oxide semiconductor layers.

In the oxide semiconductor film having such a three-layer stacked structure, the first to third oxide semiconductor layers are preferably selected so that the oxide semiconductor film has a well-shaped band structure where the energy difference between a vacuum level and the bottom of the conduction band of the second oxide semiconductor layer is greater than that of the first oxide semiconductor layer and that of the third oxide semiconductor layer. By making the constituent elements of the stacked oxide semiconductor layers the same each other, the bottoms of the conduction bands of the first to third oxide semiconductor layers have a continuous shape. That is, the oxide semiconductor film has a U-shape well band structure. With such an oxide semiconductor film, the amount of change in the threshold voltage of a transistor due to change over time or a reliability test can be reduced.

### <Source Line, Source Electrode, and Drain Electrode>

The source line 208a, the source line 208b, and the conductive film 210 serving as the other of the source electrode and the drain electrode of the transistor 102 are formed in the same layer. These may be formed of a single layer or a stacked layer of a conductive film containing one or more kinds of aluminum, titanium, chromium, cobalt, nickel, copper, yttrium, zirconium, molybdenum, ruthenium, silver, tantalum, and tungsten.

For example, as illustrated in FIGS. 9A and 9B, the source line 208a can include a 50-nm-thick tungsten layer 208aa, a 400-nm-thick aluminum layer 208ab over the tungsten layer 208aa, and a 100-nm-thick titanium layer 208ac over the aluminum layer 208ab. Further, as illustrated in FIGS. 9A and 9B, the conductive film 210 can include a 50-nm-thick tungsten layer 210a, a 400-nm-thick aluminum layer 210b over the tungsten layer 210a, and a 100-nm-thick titanium layer 210c over the aluminum layer 210b. The source line 208b can have a structure similar to those of the source line 208a and the conductive film 210.

### <Protective Insulating Film>

The protective insulating film 211 may be formed of a single layer or a stacked layer using an insulating film containing one or more kinds of aluminum oxide, magnesium oxide, silicon oxide, silicon oxynitride, silicon nitride oxide, silicon nitride, gallium oxide, germanium oxide, yttrium oxide, zirconium oxide, lanthanum oxide, neodymium oxide, hafnium oxide, and tantalum oxide.

The protective insulating film 211 may be, for example, a multi-layer film including a silicon oxide layer as a first layer and a silicon nitride layer as a second layer. In this case, a silicon oxynitride layer may be used instead of the silicon oxide layer. Further, a silicon nitride oxide layer may be used instead of the silicon nitride layer. As the silicon oxide layer or the silicon oxynitride layer, as in the case of the gate insulating film 205, a silicon oxide layer or a silicon oxynitride layer with a low defect density is preferably used. As the silicon nitride layer or the silicon nitride oxide layer, a silicon nitride layer or a silicon nitride oxide layer from which hydrogen and ammonia are less likely to be released is used. The amount of released hydrogen and ammonia may be measured by TDS analysis. As the silicon nitride layer or the silicon nitride oxide layer, a silicon nitride layer or a silicon nitride oxide layer which does not transmit or hardly transmits oxygen is used.

A silicon oxide layer or a silicon oxynitride layer which contains excess oxygen and from which oxygen is released by heat treatment or the like may be provided between the first layer and the second layer. As the silicon oxide layer containing excess oxygen, a silicon oxide layer represented by SiOₓ (x>2) may be used. In the silicon oxide layer represented by SiOₓ (x>2), the number of oxygen atoms per unit volume is more than twice the number of silicon atoms per unit volume. The number of silicon atoms and the number of oxygen atoms per unit volume are measured by Rutherford backscattering spectrometry.

As the protective insulating film 211, for example, as illustrated in FIGS. 9A and 9B, a structure may be employed in which the protective insulating film 211 includes the first silicon oxynitride layer 211a, the second silicon oxynitride layer 211b over the first silicon oxynitride layer 211a, and the silicon nitride layer 211c over the second silicon oxynitride layer 211b.

The first silicon oxynitride layer 211a has a low defect density. The second silicon oxynitride layer 211b contains excess oxygen. The hydrogen content and the ammonia content in the silicon nitride layer 211c are small, and the silicon nitride layer 211c hardly transmits oxygen.

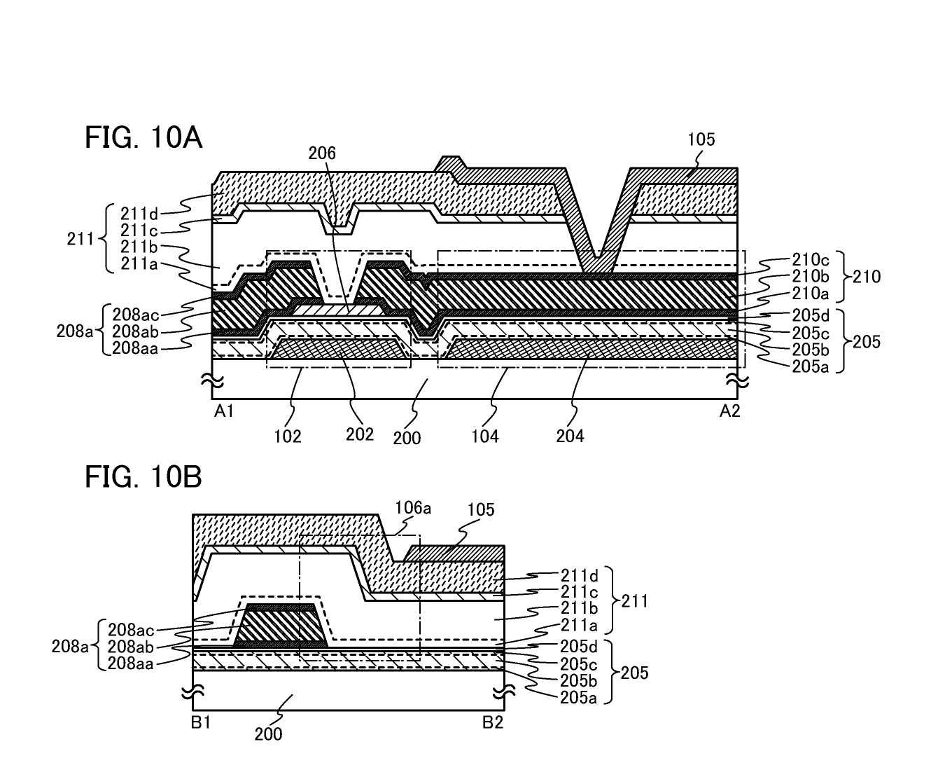

As another structural example of the first silicon oxynitride layer 211, as illustrated in FIGS. 10A and 10B, the protective insulating film 211 may include the first silicon oxynitride layer 211a, the second silicon oxynitride layer 211b over the first silicon oxynitride layer 211a, the silicon nitride layer 211c over the second silicon oxynitride layer 211b, and the silicon oxide layer 211d over the silicon nitride layer 211c. The liquid crystal display device illustrated in FIGS. 10A and 10B has the same structure as the liquid crystal display device illustrated in FIGS. 9A and 9B except that the silicon oxide layer 211d is included in the protective insulating film 211.

The silicon oxide layer 211d is formed using an organosilane gas and has excellent step coverage, and thus, is useful as a protective insulating film of the transistor 102. As the organosilane gas, any of the following silicon-containing compound can be used: tetraethyl orthosilicate (TEOS) (chemical formula: Si(OC₂H₅)₄); tetramethylsilane (TMS) (chemical formula: Si(CH₃)₄); tetramethylcyclotetrasiloxane (TMCTS); octamethylcyclotetrasiloxane (OMCTS); hexamethyldisilazane (HMDS); triethoxysilane (SiH(OC₂H₅)₃); trisdimethylaminosilane (SiH(N(CH₃)₂)₃); or the like.

When the silicon oxide layer 211d is used as the surface of the protective insulating film 211, the distance between the source line 208a and the left end of the pixel electrode 105 and the distance between the source line 208b and the right end of the pixel electrode 105 can be wider, so that the capacitance value of the first parasitic capacitance 106a and the capacitance value of the second parasitic capacitance 106b can be lowered. Further, the planarity of the surface of an element portion on which a transistor and a capacitor are formed can be reduced.

### <Pixel Electrode>

The pixel electrode 105 can be formed using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, or indium tin oxide to which silicon oxide is added.

In the planar shape of FIG. 7, the pixel electrode 105 does not overlap with the source line 208a, the source line 208b, the gate line 202, and a gate line of an adjacent pixel in the row direction. Accordingly, an increase in parasitic capacitance formed between the pixel electrode 105 and these wirings is suppressed. Note that the liquid crystal display device described in this embodiment is not limited thereto.

In the liquid crystal display device of one embodiment of the present invention, in order to prevent the entry of impurities such as hydrogen and moisture which may generate carriers in the oxide semiconductor film 206, a planarization film formed of an inorganic insulator such as an acrylic resin, a polyimide resin, a benzocyclobutene-based resin, a polyamide resin, or an epoxy resin is not provided.

However, the present invention is not limited thereto, and the following structure may be used. An insulating film or the like which can sufficiently prevent the entry of impurities such as hydrogen and moisture which may generate carriers in the oxide semiconductor film 206 is provided as the protective insulating film 211, and a planarization film formed of any of the above inorganic insulators is provided.

### Modification Example 1 of Structure of Pixel

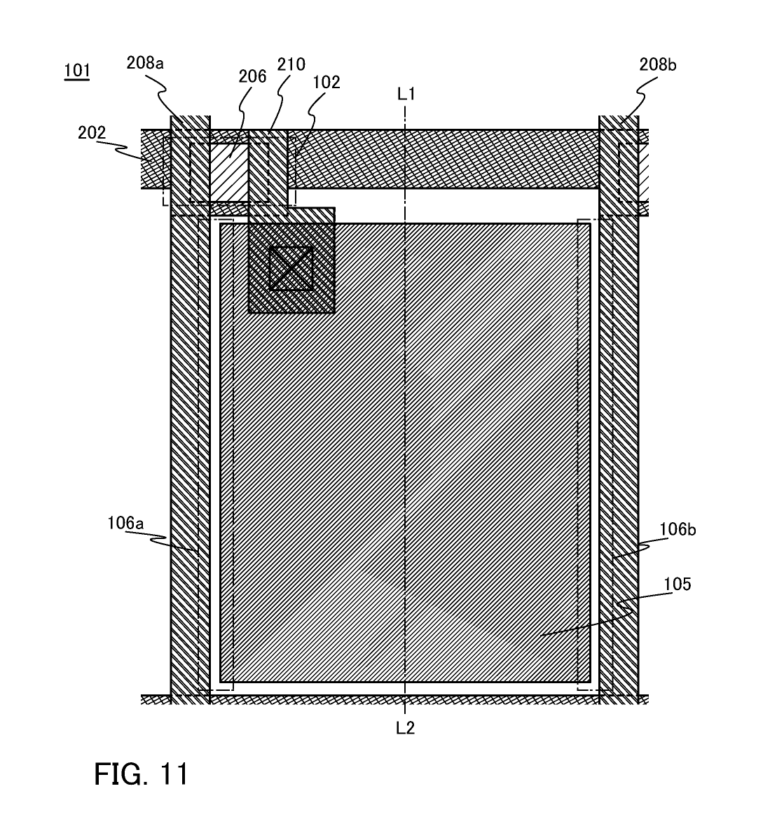

As the liquid crystal display device of one embodiment of the present invention, a structure where the capacitor line 204 is provided to form the capacitor 104 is illustrated in FIG. 7; however, the present invention is not limited thereto. In the case where sufficient capacitance can be formed in the pixel electrode even if a capacitor line is not provided intentionally, the liquid crystal display device may have a structure of the pixel in which a capacitor line is not provided in FIG. 11. At this time, a capacitor including a capacitor line does not exist; thus, the capacitance value of the capacitor is 0 fF in an equivalent circuit diagram. The structure of the pixel of the liquid crystal display device in FIG. 11 is the same as that of the pixel of the liquid crystal display device in FIG. 7 except that the capacitor line is not provided; thus, the description of FIG. 7 or the like can be referred to for the details.

### Modification Example 2 of Structure of Pixel

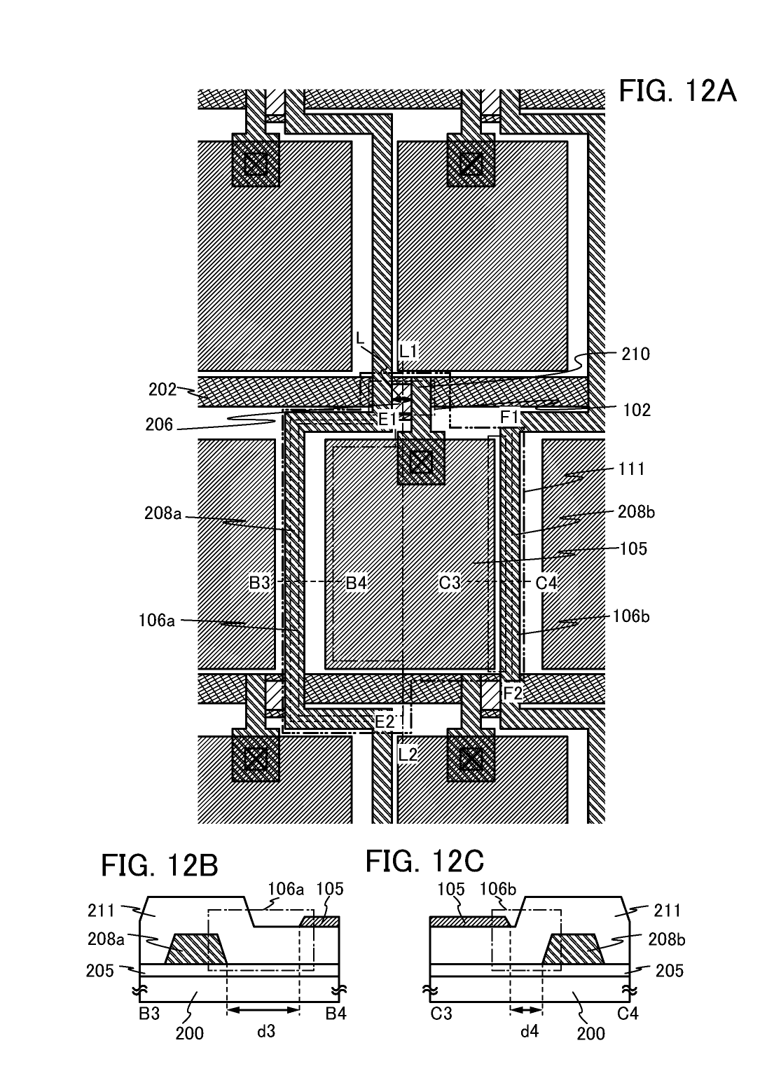

The liquid crystal display device of one embodiment of the present invention in FIG. 7 is assumed to have a stripe arrangement in which a plurality of pixels are provided in a matrix; however, the present invention is not limited thereto. For example, as illustrated in FIG. 12A, a structure in which a plurality of pixels is provided in a delta arrangement can also be used. In the pixel structures in FIG. 7 and FIG. 11, the source lines are provided in a straight line and extend in the row direction. In the case where the pixels are provided in a delta arrangement as illustrated in FIG. 12A, the source lines are provided to each have an S-shaped curve in accordance with the delta arrangement of a pixel 111 and extend in the column direction. The pixel structure illustrated in FIG. 12A is the same as that of the liquid crystal display device in FIG. 11 except that the source lines are provided to each have an S-shaped curve and extend in the column direction. The source lines extend in the low direction. And a channel length direction of the transistor are provided parallel to the low direction. Although a capacitor line is not provided in the pixel structure in FIG. 12A, a capacitor line can be provided similarly to the pixel structure in FIG. 7. Thus, for the details of the pixel structure of the liquid crystal display device illustrated in FIGS. 12A to 12C, the description of FIG. 7 and FIG. 11 can be referred to.

In the pixel 111 in FIG. 12A, the source line 208a is provided to have a curve near the pixel, and is provided close to the pixel electrode 105 at not only the left end of the pixel electrode 105 but also part of the top and bottom end portions of the pixel electrode 105. Accordingly, the first parasitic capacitance 106a formed between the pixel electrode 105 and the source line 208a is formed at not only the left end of the pixel electrode 105 but also part of the top and bottom end portions of the pixel electrode 105. In contrast, the second parasitic capacitance 106b formed between the pixel electrode 105 and the source line 208b is formed at only the right end of the pixel electrode 105 similarly to the second parasitic capacitance 106b in FIG. 7. In other words, the region where the first parasitic capacitance 106a is formed is greater than the region where the second parasitic capacitance 106b is formed by the region of capacitance formed at the part of the top and bottom end portions of the pixel electrode 105.

When the pixel electrode 105 has a planar shape which is almost symmetrical about the bisector L1-L2 of the source line 208a and the source line 208b as described above, the capacitance value of the first parasitic capacitance 106a becomes greater than that of the second parasitic capacitance 106b because the region where the first parasitic capacitance 106a is formed is large.

Thus, in the case of the delta arrangement illustrated in FIG. 12A, it is necessary to provide the pixel electrode 105 with adjustment of the planar shape of the pixel electrode 105 in accordance with the ratio of the area where the first parasitic capacitance 106a is formed to the area where the second parasitic capacitance 106b is formed.

For example, assuming that a length s1 (illustrated in a dotted line E1-E2) in FIG. 12A is the length of the portion of the source line 208a where the first parasitic capacitance 106a is formed, a length s2 (illustrated in a dotted line F1-F2) in FIG. 12A is the length of the portion of the source line 208b where the second parasitic capacitance 106b is formed, a distance d3 in FIG. 12B is the distance between the source line 208a and the left end of the pixel electrode 105, and a distance d4 in FIG. 12C is the distance between the source line 208b and the right end of the pixel electrode 105, the distance d3 may be made larger than the distance d4 by the ratio of the length s1 to the length s2. Thus, the planar shape of the pixel electrode 105 may be set so that s1:s2=d3:d4. Here, FIG. 12B is a cross-sectional view taken along dotted line B3-B4 of FIG. 12A, and FIG. 12C is a cross-sectional view taken along dotted line C3-C4 of FIG. 12A. For stricter calculation, the calculation may be performed using the thickness of the protective insulating film 211, the distance between the pixel electrode 105 and the top end portion of the source line 208a, and the distance between the pixel electrode 105 and the bottom end portion of the source line 208a.

### <Example of Manufacturing Steps of Pixel>

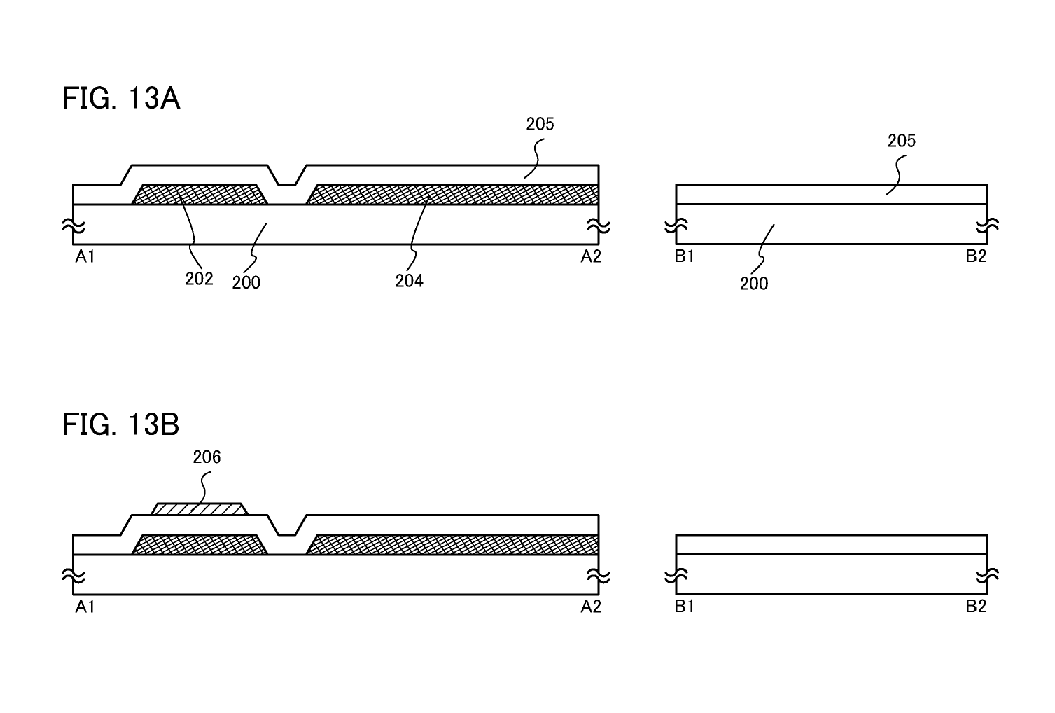

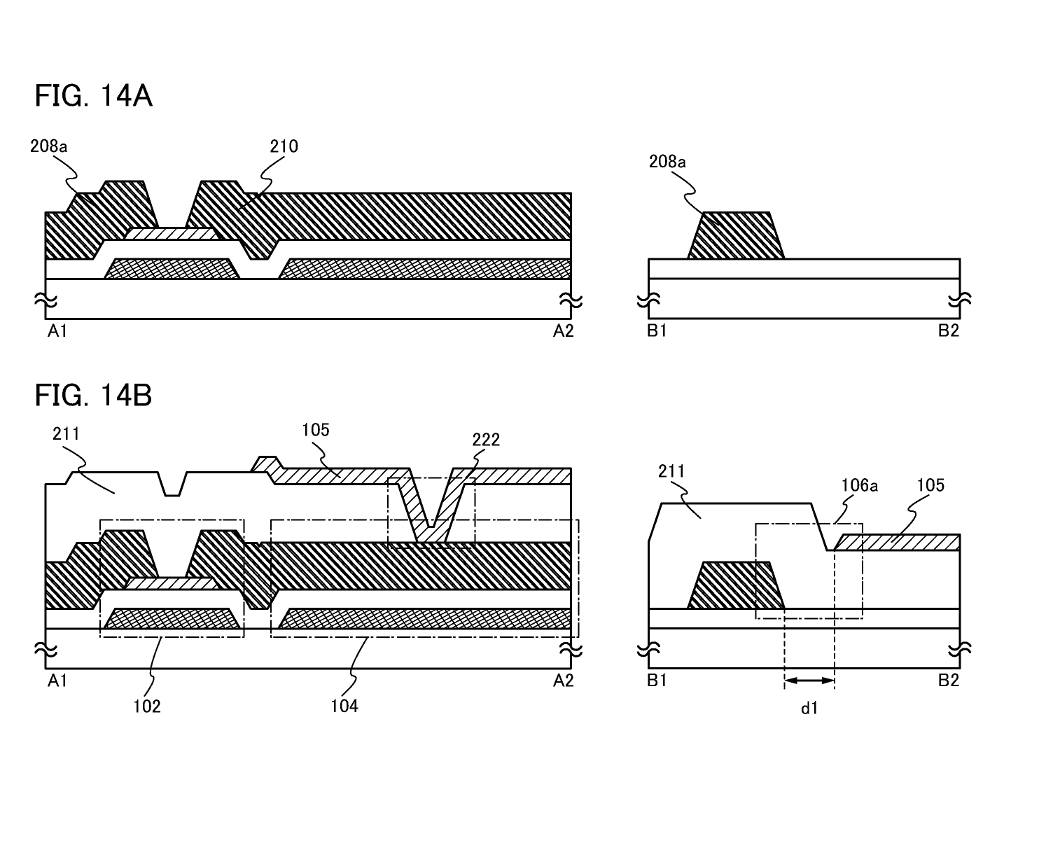

Next, an example of manufacturing steps of the liquid crystal display device illustrated in FIG. 7 and FIGS. 8A to 8C is described with reference to FIGS. 13A and 13B and FIGS. 14A and 14B. FIGS. 13A and 13B and FIGS. 14A and 14B show cross-sectional views taken along dashed-dotted line A1-A2 and dashed-dotted line B1-B2.

First, a conductive film which can be used for the gate line 202 is formed over the substrate 200. The conductive film can be formed by a sputtering method, a chemical vapor deposition (CVD) method, a molecular beam epitaxy (MBE) method, an atomic layer deposition (ALD) method, or a pulsed laser deposition (PLD) method.

Next, the conductive film is selectively patterned by a photolithography method using a first mask, so that the gate line 202 and the capacitor line 204 are formed. For the patterning of the conductive film, dry etching or wet etching may be used.

Then, an insulating film which can be used for the gate insulating film 205 is formed over the gate line 202 and the capacitor line 204, so that the gate insulating film 205 is formed (see FIG. 13A). Here, the gate insulating film 205 can be formed by a sputtering method, a CVD method, an MBE method, an ALD method, or a PLD method.

In the case where the gate insulating film 205 is formed to include the first silicon nitride layer 205a, the second silicon nitride layer 205b, the third silicon nitride layer 205c, and the silicon oxynitride layer 205d as illustrated in FIGS. 9A and 9B, for example, these layers may be successively formed without exposure to the air by a plasma CVD method as described below. First, the first silicon nitride layer 205a is formed by a plasma CVD method using a mixed gas of silane (SiH₄), nitrogen (N₂), and ammonia (NH₃). The amount of supplied ammonia is smaller than that of ammonia during the deposition of the second silicon nitride layer 205b. Subsequently, the second silicon nitride layer 205b is formed by a plasma CVD method using a mixed gas of silane (SiH₄), nitrogen (N₂), and ammonia (NH₃). After that, the third silicon nitride layer 205c is formed by a plasma CVD method using a mixed gas of silane (SiH₄) and nitrogen (N₂). Finally, the silicon oxynitride layer 205d is formed by a plasma CVD method using a mixed gas of silane (SiH₄) and dinitrogen monoxide (N₂O).

Further, in the case of making the silicon oxynitride layer 205d contain excess oxygen, oxygen (including at least one of an oxygen radical, an oxygen atom, and an oxygen ion) is introduced by an ion implantation method, an ion doping method, a plasma immersion ion implantation method, plasma treatment, or the like, so that a layer containing excess oxygen is formed.

In the case of providing a base insulating film, a base insulating film may be formed by a similar method to that of the gate insulating film 205 before the conductive film to be the gate line 202 is formed.

Next, an oxide semiconductor film which can be used as the oxide semiconductor film 206 is formed over the gate insulating film 205 and then is selectively patterned by a photolithography method or the like using a second mask, so that the oxide semiconductor film 206 is formed (see FIG. 13B).

The oxide semiconductor film can be formed by a sputtering method, a coating method, a pulsed laser deposition method, a laser ablation method, or the like. In the case where the oxide semiconductor film is formed by a sputtering method, an RF power supply device, an AC power supply device, a DC power supply device, or the like can be used as appropriate as a power supply device for generating plasma. As an atmosphere of a sputtering as, a rare gas (typically argon), an oxygen gas, or a mixed gas of a rare gas and oxygen is used as appropriate. In the case of using the mixed gas of a rare gas and oxygen, the proportion of oxygen is preferably higher than that of a rare gas. Further, a target may be appropriately selected in accordance with the composition of the oxide semiconductor film to be formed.

For example, in the case of forming a CAAC-OS film by a sputtering method, the substrate heating temperature is higher than or equal to 100° C. and lower than or equal to 600° C., preferably higher than or equal to 150° C. and lower than or equal to 550° C., further preferably higher than or equal to 200° C. and lower than or equal to 500° C. The CAAC-OS film is formed in an oxygen gas atmosphere with a deposition pressure of 0.8 Pa or lower, preferably 0.4 Pa or lower. The distance between a target and the substrate is smaller than or equal to 40 nm, preferably smaller than or equal to 25 nm.

The patterning of the oxide semiconductor film may be performed by dry etching or wet etching, and the etching conditions such as an etching gas, an etching solution, etching time, and temperature may be set as appropriate depending on the material. By the etching, the gate insulating film 205 has a small thickness in a region not overlapping with the oxide semiconductor film 206 in some cases.

The oxide semiconductor film 206 is preferably subjected to heat treatment. The heat treatment may be performed at a temperature higher than or equal to 250° C. and lower than or equal to 650° C., preferably higher than or equal to 300° C. and lower than or equal to 500° C. The heat treatment is performed in an inert gas atmosphere, an atmosphere containing an oxidizing gas at 10 ppm or more, preferably 1% or more, further preferably 10% or more, or under reduced pressure. As the atmosphere of the heat treatment, after the heat treatment is performed in an inert gas atmosphere, an atmosphere containing an oxidizing gas at 10 ppm or more, 1% or more, or 10% or more may be used in order to compensate desorbed oxygen. The heat treatment may be performed plural times. In that case, heat treatment may be further performed in a later step, for example, after the source line 208a and the source line 208b are formed.

By the heat treatment, the crystallinity of the oxide semiconductor film 206 can be improved, and in addition, impurities such as hydrogen and water can be removed from the gate insulating film 205 and/or the oxide semiconductor film 206. With the oxide semiconductor film 206 having the three-layer structure, oxygen can be diffused between the first to third oxide semiconductor layers.

The heat treatment may be performed using the electric furnace or an apparatus for heating an object by thermal conduction or thermal radiation from a medium such as a heated gas. For example, a rapid thermal anneal (RTA) apparatus such as a gas rapid thermal anneal (GRTA) apparatus or a lamp rapid thermal anneal (LRTA) apparatus can be used. A GRTA apparatus is an apparatus for heat treatment using a high-temperature gas. An LRTA apparatus is an apparatus for heating an object to be processed by radiation of light (an electromagnetic wave) emitted from a lamp such as a halogen lamp, a metal halide lamp, a xenon arc lamp, a carbon arc lamp, a high pressure sodium lamp, or a high pressure mercury lamp.

The heat treatment may be performed before the oxide semiconductor film 206 is patterned.

Next, a conductive film which can be used for the source line 208a, the source line 208b, and the conductive film 210 is formed over the oxide semiconductor film 206 and the gate insulating film 205. Here, the conductive film can be formed by a sputtering method, a CVD method, an MBE method, an ALD method, or a PLD method.

In the case of forming the source line 208a including the tungsten layer 208aa, the aluminum layer 208ab over the tungsten layer 208aa, and the titanium layer 208ac over the aluminum layer 208ab as illustrated in FIGS. 9A and 9B, for example, a tungsten layer, an aluminum layer, and a titanium layer may be formed in this order by a sputtering method. The conductive film 210 and the source line 208b may be formed in a similar manner to that of the source line 208a.

Next, the conductive film is selectively patterned by a photolithography method or the like using a third mask, so that the source line 208a, the source line 208b (not shown), and the conductive film 210 are formed (see FIG. 14A). For the patterning of the conductive film, dry etching or wet etching may be used.

Then, an insulating film which can be used for the protective insulating film 211 is formed over the oxide semiconductor film 206, the source line 208a, the source line 208b, and the conductive film 210, so that the protective insulating film 211 is formed. Here, the protective insulating film 211 can be formed by a sputtering method, a CVD method, an MBE method, an ALD method, or a PLD method.

In the case where the protective insulating film 211 is formed to include the first silicon oxynitride layer 211a, the second silicon oxynitride layer 211b, and the silicon nitride layer 211c as illustrated in FIGS. 9A and 9B, for example, these layers may be successively formed without exposure to the air by a plasma CVD method as described below. First, the first silicon oxynitride layer 211a is formed by a plasma CVD method using a mixed gas of silane (SiH₄) and dinitrogen monoxide (N₂O). Subsequently, the second silicon oxynitride layer 211b is formed by a plasma CVD method using a mixed gas of silane (SiH₄) and dinitrogen monoxide (N₂O). In the case of making the second silicon oxynitride layer 211b contain excess oxygen, as for the formation conditions, the substrate placed in a treatment chamber of a plasma CVD apparatus, which is vacuum-evacuated, is held at a temperature higher than or equal to 180° C. and lower than or equal to 260° C., preferably higher than or equal to 180° C. and lower than or equal to 230° C., a source gas is introduced into the treatment chamber, the pressure in the treatment chamber is greater than or equal to 100 Pa and less than or equal to 250 Pa, preferably greater than or equal to 100 Pa and less than or equal to 200 Pa, and high-frequency power that is higher than or equal to 0.17 W/cm² and lower than or equal to 0.5 W/cm², preferably, higher than or equal to 0.25 W/cm² and lower than or equal to 0.35 W/cm² is supplied to an electrode provided in the treatment chamber. After that, the silicon nitride layer 211c is formed by a plasma CVD method using a mixed gas of silane (SiH₄), nitrogen (N₂), and ammonia (NH₃).

In the case of forming the silicon oxide layer 211d over the silicon nitride layer 211c as illustrated in FIGS. 10A and 10B, the silicon oxide layer 211d can be formed by a CVD method using the organosilane gas.

Next, an opening 222 is formed in a portion of the protective insulating film 211, which overlaps with the conductive film 210, by a photolithography method or the like using a fourth mask. For the patterning of the protective insulating film 211, dry etching or wet etching may be used.

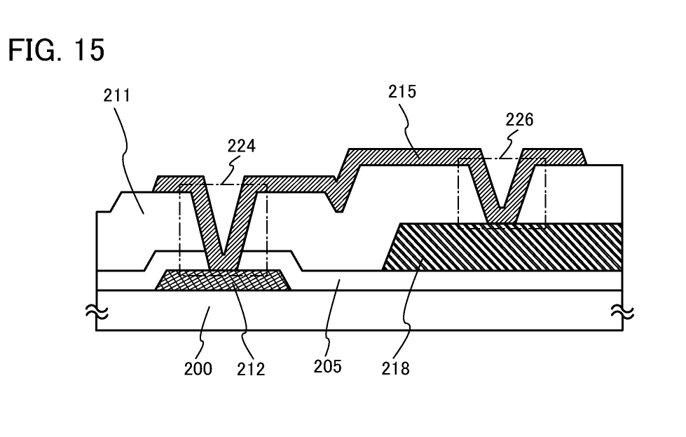

In the case where a driver circuit portion such as a gate line driver circuit is provided parallel to the pixel portion over the substrate 200, it is necessary to connect a wiring 212 which is on the same layer as the gate line 202 over the substrate 200 to a wiring 218 which is on the same layer as the source line 208a over the gate insulating film 205 as illustrated in FIG. 15.

In that case, at the same time as the formation of the opening 222, an opening 224 may be formed in portions of the gate insulating film 205 and the protective insulating film 211, which overlap with the wiring 212, and an opening 226 may be formed in a portion of the protective insulating film 211, which overlap with the wiring 218. In this manner, the openings 222, 224, and 226 can be formed using one mask.

Next, a conductive film formed using a light-transmitting conductive material which can be used for the pixel electrode 105 is formed over the protective insulating film 211. Here, the conductive film can be formed by an evaporation method, a sputtering method, a CVD method, an MBE method, an ALD method, a PLD method, or the like.

Next, the conductive film is selectively patterned by a photolithography method using a fifth mask, so that the pixel electrode 105 is formed (see FIG. 14B). The pixel electrode 105 is connected to the conductive film 210 through the opening 222. For the patterning of the conductive film, dry etching or wet etching may be used.

Here, as described above, in order to make the capacitance value of the first parasitic capacitance 106a and the capacitance value of the second parasitic capacitance 106b approximately the same, the pixel electrode 105 preferably has a planar shape which is almost symmetrical about a bisector L1-L2 of the source line 208a and the source line 208b. The pixel electrode 105 is patterned so that the difference between the distance d1 and the distance d2 is greater than or equal to −10% and smaller than or equal to 10%, preferably greater than or equal to −5% and smaller than or equal to 5% .

Further, at the same time as the formation of the pixel electrode 105, a conductive film 215 which connects the wiring 212 to the wiring 218 is also formed as illustrated in FIG. 15. Accordingly, the pixel portion and at least parts of the driver circuit portion of the liquid crystal display device can be formed over the substrate 200 at the same time using a small number of masks such as five masks. Thus, the manufacturing process of the liquid crystal display device can be simplified, so that the manufacturing costs can be reduced.

The wiring 212 and the wiring 218 are not necessarily connected through the conductive film 215. For example, after the step illustrated in FIG. 13A, an opening corresponding to the opening 224 is formed in the gate insulating film 205 so as to overlap with the wiring 212, and the wiring 212 may be directly connected to the wiring 218 through the opening.

In the above manner, the pixel portion of the liquid crystal display device in FIG. 7 and FIGS. 8A to 8C including the transistor 102 and the capacitor 104 can be manufactured.

### <Specific Structure of Liquid Crystal Display Device>

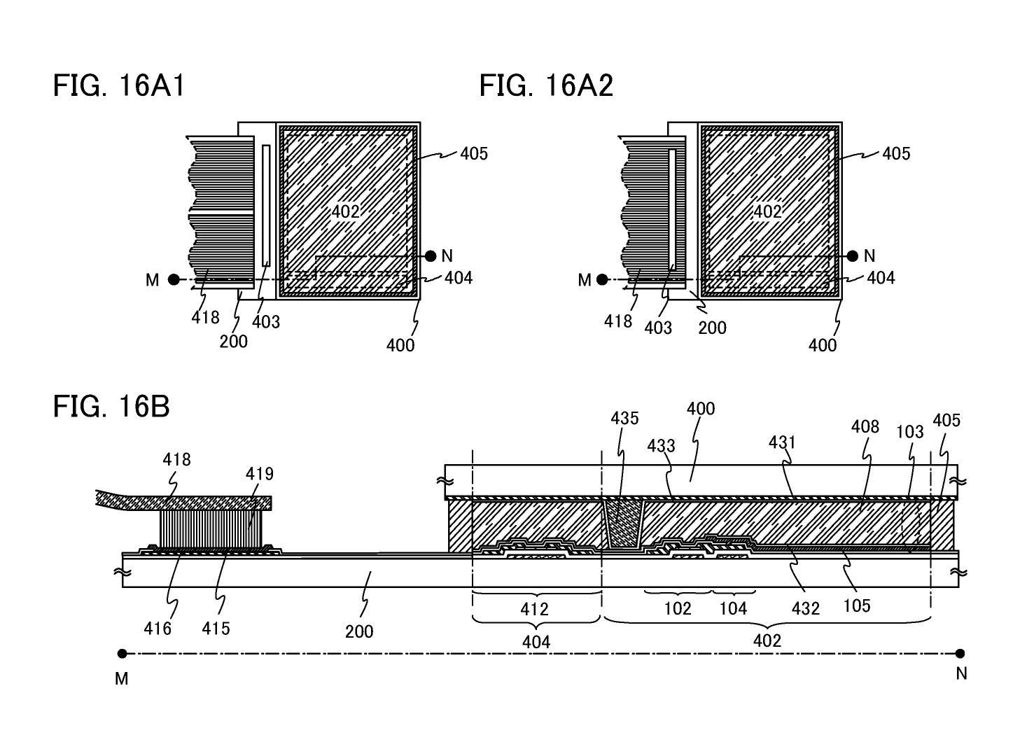

Next, an example of a specific structure of the panel of the liquid crystal display device of one embodiment of the present invention is described with reference to FIGS. 16A1, 16A2, and 16B.

Note that the liquid crystal display device includes the following modules in its category: a module including a connector such as a flexible printed circuit (FPC), a tape automated bonding (TAB) tape, or a tape carrier package (TCP); a module having a TAB tape or a TCP that is provided with a printed wiring board at the end thereof; and a module having an integrated circuit (IC) that is directly mounted on a display element by a chip on glass (COG) method.

The appearances and a cross section of the liquid crystal display device of one embodiment of the present invention are described with reference to FIGS. 16A1, 16A2, and 16B. FIGS. 16A1 and 16A2 are each a plan view of a panel in which the transistor 102 provided in a pixel portion 402, a transistor 412 provided in a gate line driver circuit 404, and the liquid crystal element 103 are sealed by a sealant 405 between the substrate 200 and a counter substrate 400. FIG. 16B corresponds to a cross-sectional view taken along line M-N in FIGS. 16A1 and 16A2.

The sealant 405 is provided to surround the pixel portion 402 and the gate line driver circuit 404 provided over the substrate 200. The counter substrate 400 is provided over the pixel portion 402 and the gate line driver circuit 404. Therefore, the pixel portion 402 and the gate line driver circuit 404 are sealed together with a liquid crystal layer 408 by the substrate 200, the sealant 405, and the counter substrate 400. A source line driver circuit 403 that is formed using a single crystal semiconductor film or a polycrystalline semiconductor film over a substrate separately prepared is mounted in a region that is different from the region surrounded by the sealant 405 over the substrate 200.

Note that in the pixel portion 402 over the substrate 200, a pixel including the transistor 102, the capacitor 104, and the pixel electrode 105 is formed as described above, and the above description can be referred to for the details of their structures.

Although not illustrated in FIGS. 16A1, 16A2, and 16B, a coloring layer which serves as a color filter layer can be further provided.

Further, a backlight that emits light to pixels can be provided as appropriate as a light source. As the backlight, a white light-emitting diode (LED) may be used, and white light may be emitted by combining some colors such as red (R), green (G), and blue (B). With the use of light-emitting diodes of each color, color reproducibility can be increased, so that the tone of white can be adjusted. For example, it is said that blue light with a wavelength of 380 nm to 420 nm causes strain on eyes. By adjusting a light-emitting diode which emits light having such a wavelength or light partly having such a wavelength, a liquid crystal display device which can reduce eyestrain can be provided. In particular, the liquid crystal display device with the structure in which the transistor having an extremely low off-state current is used, so that the holding time in the pixel electrode is extended and the writing frequency of the video signals is reduced is expected to have a great effect when used for a working display such as a personal computer.

Note that there is no particular limitation on the connection method of a driver circuit which is separately formed, and a COG method, a wire bonding method, a TAB method, or the like can be used. FIG. 16A1 illustrates an example of mounting the source line driver circuit 403 by a COG method, and FIG. 16A2 illustrates an example of mounting the source line driver circuit 403 by a TAB method.

The pixel portion 402 and the gate line driver circuit 404 provided over the substrate 200 include a plurality of transistors. FIG. 16B illustrates the transistor 102 included in the pixel portion 402 and the transistor 412 included in the gate line driver circuit 404, as an example. The transistor 412 can be formed by similar steps as those of the transistor 102; thus, the description of the transistor 102 can be referred to for the details.

A pixel electrode 105 included in the liquid crystal element 103 is connected to the transistor 102. A counter electrode 431 of the liquid crystal element 103 is formed on the counter substrate 400. A portion where the pixel electrode 105, the counter electrode 431, and the liquid crystal layer 408 overlap with one another corresponds to the liquid crystal element 103. Note that the pixel electrode 105 and the counter electrode 431 are provided with an insulating layer 432 and an insulating layer 433 serving as alignment films, respectively, and the liquid crystal layer 408 is sandwiched between the pixel electrode 105 and the counter electrode 431 with the insulating layers 432 and 433 interposed therebetween.

As the counter substrate 400, as well as the substrate 200, a light-transmitting substrate such as a glass substrate, a ceramic substrate, a plastic substrate, or the like can be used. For a plastic substrate, a fiberglass-reinforced plastics (FRP) plate, a polyvinyl fluoride (PVF) film, a polyester film, or an acrylic resin film can be used.

A structure body 435 is a columnar spacer obtained by selectively etching an insulating film and is provided to control the distance (cell gap) between the pixel electrode 105 and the counter electrode 431. Alternatively, a spherical spacer may also be used. The counter electrode 431 is electrically connected to a common potential line formed over the substrate where the transistor 102 is formed. With the use of the common contact portion, the counter electrode 431 and the common potential line can be connected to each other by conductive particles arranged between a pair of substrates. Note that the conductive particles can be included in the sealant 405.

Note that a structure of an electrode of a liquid crystal element can be changed as appropriate depending on the display mode of the liquid crystal element. For example, as the display mode of the liquid crystal element, a twisted nematic (TN) mode, a vertical alignment (VA) mode where liquid crystal molecules are aligned perpendicularly to a substrate when there is no electrical field, a multi-domain vertical alignment (MVA) mode where protrusions are provided so that liquid crystal molecules are aligned in a plurality of directions to compensate the viewing angle dependence, or the like can be used.

This embodiment shows the example of the liquid crystal display device in which a polarizing plate is provided on the outer side of the substrate (on the viewer side) and a coloring layer and an electrode layer used for a display element are provided in this order on the inner side of the substrate; alternatively, a polarizing plate may be provided on the inner side of the substrate. The stack structure of the polarizing plate and the coloring layer is not limited to that described in this embodiment and may be set as appropriate depending on materials of the polarizing plate and the coloring layer or conditions of manufacturing steps. Further, a light-blocking film serving as a black matrix may be provided in a portion other than the display portion. A light-blocking film serving as a black matrix may be provided to overlap with the transistor 102 or the wiring layer in the pixel portion 402 and include an opening over the pixel electrode 105.

The counter electrode 431 can be formed similarly to the pixel electrode 105 using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, or indium tin oxide to which silicon oxide is added.

Further, various signals and potentials are supplied to the source line driver circuit 403 which is separately formed, the gate line driver circuit 404, or the pixel portion 402 from an FPC 418.

A connection terminal electrode 415 is formed of the same conductive film as the pixel electrode 105 included in the liquid crystal element 103. A terminal electrode 416 is formed of the same conductive film as the source electrode layers and the drain electrode layers of the transistor 102 and the transistor 412.

The connection terminal electrode 415 is electrically connected to a terminal included in the FPC 418 through an anisotropic conductive film 419.

Although FIGS. 16A1, 16A2, and 16B show the example in which the source line driver circuit 403 is formed separately and mounted on the first substrate 200, this embodiment is not limited to this structure. The gate line driver circuit may be separately formed and then mounted, or only part of the source line driver circuit or part of the gate line driver circuit may be separately formed and then mounted.

### <Application Example of Liquid Crystal Display Device>

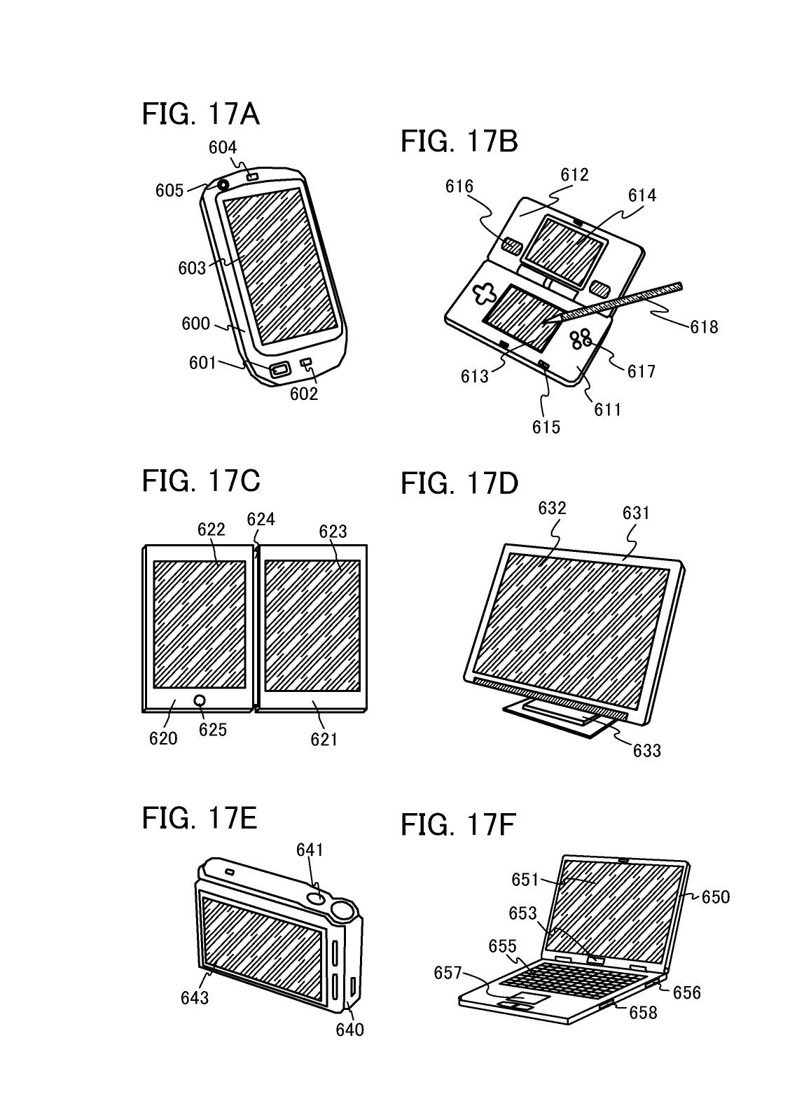

Next, electronic devices each including a liquid crystal display device of one embodiment of the present invention is described with reference to FIGS. 17A to 17E. Examples of such electronic devices include television sets, cameras such as video cameras and digital cameras, goggle-type displays, navigation systems, audio replay devices (e.g., car audio systems and audio systems), computers, game machines, portable information terminals (e.g., portable computers, mobile phones, mobile phones with advanced features (smartphones), portable game machines, e-book readers, and tablet terminals), and image replay devices provided with a recording medium (specifically, devices that are capable of replaying recording media and equipped with a display device that can display an image). Hereinafter, specific structures are described.

FIG. 17A shows an external view of a mobile phone with advanced features (smartphone) including the liquid crystal display device of one embodiment of the present invention. The mobile phone with advanced features illustrated in FIG. 17A includes a housing 600, a button 601, a microphone 602, a display portion 603, a speaker 604, a camera 605, and the like. The display portion 603 has a touch panel function. By touching a symbol displayed on the display portion 603, a variety of application for a telephone function, a web browser function, a game function, and the like can be utilized.

It is possible to use the liquid crystal display device of one embodiment of the present invention as the display portion 603. With the use of the liquid crystal display device of one embodiment of the present invention as the display portion of such a mobile phone with advanced features, a mobile phone with advanced features which can display high-definition images and has an extremely long continuous operating time can be provided.

FIG. 17B shows an external view of a portable game machine including the liquid crystal display device of one embodiment of the present invention. The portable game machine illustrated in FIG. 17B includes a housing 611, a housing 612, a display portion 613, a display portion 614, a microphone 615, a speaker 616, an operation button 617, a stylus 618, and the like. Since the display portion 613 and the display portion 614 are included, for example, the display portion 614 can have a normal display function and the display portion 613 can have a touch panel function.

It is possible to use the liquid crystal display device of one embodiment of the present invention as the display portion 613 and the display portion 614. With the use of the liquid crystal display device of one embodiment of the present invention as the display portion of such a portable game machine, a portable game machine which can display high-definition images and has an extremely long continuous operating time can be provided.

FIG. 17C shows an external view of a foldable tablet terminal including the liquid crystal display device of one embodiment of the present invention. The tablet terminal illustrated in FIG. 17C includes a housing 620, a housing 621, a display portion 622, a display portion 623, a hinge 624, an operation switch 625, and the like. The housing 620 including the display portion 622 is connected to the housing 621 including the display portion 623 by the hinge 624.

Part or all of the display portion 622 and/or the display portion 623 can have a touch panel function. By touching a displayed symbol, a variety of application for an information processing function, a web browser function, a game function, and the like can be utilized.

It is possible to use the liquid crystal display device of one embodiment of the present invention as the display portion 622 and the display portion 623. With the use of the liquid crystal display device of one embodiment of the present invention as the display portion of such a tablet terminal, a tablet terminal which can display high-definition images and has an extremely long continuous operating time can be provided.

FIG. 17D shows an external view of a display including the liquid crystal display device of one embodiment of the present invention. The display illustrated in FIG. 17D includes a housing 631, a display portion 632, a support 633, and the like. Such a display can be widely used for a personal computer, TV broadcast reception, advertisement display, and the like.

It is possible to use the liquid crystal display device of one embodiment of the present invention as the display portion 632. With the use of the liquid crystal display device of one embodiment of the present invention as the display portion of such a display, a display which can display high-definition images and has an extremely long continuous operating time can be provided.

FIG. 17E shows an external view of a digital camera including the liquid crystal display device of one embodiment of the present invention. The digital camera machine illustrated in FIG. 17E includes a housing 640, an operation button 641, a display portion 643, and the like. The display portion 643 can have a touch panel function. By touching a symbol displayed on the display portion 643, the digital camera may be operated.

It is possible to use the liquid crystal display device of one embodiment of the present invention as the display portion 643. With the use of the liquid crystal display device of one embodiment of the present invention as the display portion of such a digital camera, a digital camera which can display high-definition images and has an extremely long continuous operating time can be provided.

FIG. 17F shows an external view of a portable computer including the liquid crystal display device of one embodiment of the present invention. The portable computer illustrated in FIG. 17F includes a housing 650, a display portion 651, a speaker 653, an operation button 655, a connection terminal 656, a pointing device 657, an external connection port 658, and the like. The computer in FIG. 17F can have a function of displaying a variety of information (e.g., a still image, a moving image, and a text image) on the display portion, a function of controlling processing by a variety of software (programs), a communication function such as wireless communication or wired communication, a function of being connected to various computer networks with the communication function, a function of transmitting or receiving a variety of data with the communication function, and the like.

It is possible to use the liquid crystal display device of one embodiment of the present invention as the display portion 651. With the use of the liquid crystal display device of one embodiment of the present invention as the display portion of such a portable computer, a portable computer which can display high-definition images and has an extremely long continuous operating time can be provided. This application is based on Japanese Patent Application serial No. 2012-226973 filed with Japan Patent Office on Oct. 12, 2012, the entire contents of which are hereby incorporated by reference.

What is claimed is:

1. A liquid crystal display device comprising:
a plurality of gate lines extending in a row direction;
a plurality of source lines extending in a column direction; and
a plurality of pixels which is electrically connected to the plurality of gate lines and the plurality of source lines and is provided in a matrix,
wherein the plurality of pixels comprises:
a transistor which is electrically connected to a first gate line and a first source line and includes an oxide semiconductor; and
a pixel electrode electrically connected to the transistor,
wherein polarities of video signals input to the first source line are different from polarities of video signals input to the second source line which is provided to be adjacent to the first source line with the pixel electrode positioned therebetween, and
wherein a difference between a capacitance value of capacitance formed between the pixel electrode and the first source line and a capacitance value of capacitance formed between the pixel electrode and the second source line is greater than or equal to −10% and smaller than or equal to 10%.

2. The liquid crystal display device according to claim 1, wherein the pixel electrode has a planar shape which is almost symmetrical about a bisector of the first source line and the second source line.

3. The liquid crystal display device according to claim 1, wherein the distance between a first wiring and an end portion of the pixel electrode on the first wiring side is approximately the same as that between a second wiring and an end portion of the pixel electrode on the second wiring side.

4. The liquid crystal display device according to claim 1,
wherein a plurality of capacitor lines is provided in a same layer as the plurality of gate lines, and
wherein in each of the pixels, a capacitance value of the capacitor including one of the capacitor lines is smaller than or equal to 30 fF.

5. The liquid crystal display device according to claim 1, wherein 300 or more of the gate lines and 300 or more of the source lines are provided in each inch.

6. The liquid crystal display device according to claim 1, wherein the oxide semiconductor has a wider band gap and a lower intrinsic carrier density than silicon.

7. A liquid crystal display device comprising:
a plurality of gate lines extending in a row direction;
a plurality of source lines having an S-shaped curve; and
a plurality of pixels which is electrically connected to the plurality of gate lines and the plurality of source lines and is provided in a matrix,
wherein the plurality of pixels comprises:
a transistor which is electrically connected to a first gate line and a first source line and includes an oxide semiconductor; and
a pixel electrode electrically connected to the transistor,
wherein a channel length direction of the transistor are provided parallel to the low direction,
wherein a difference between a capacitance value of capacitance formed between the pixel electrode and the first source line and a capacitance value of capacitance formed between the pixel electrode and the second source line is greater than or equal to −10% and smaller than or equal to 10%.

8. The liquid crystal display device according to claim 7, wherein the pixel electrode has a planar shape which is almost symmetrical about a bisector of the first source line and the second source line.

9. The liquid crystal display device according to claim 7, wherein the distance between a first wiring and an end portion of the pixel electrode on the first wiring side is approximately the same as that between a second wiring and an end portion of the pixel electrode on the second wiring side.

10. The liquid crystal display device according to claim 7,
wherein a plurality of capacitor lines is provided in a same layer as the plurality of gate lines, and
wherein in each of the pixels, a capacitance value of the capacitor including one of the capacitor lines is smaller than or equal to 30 fF.

11. The liquid crystal display device according to claim 7, wherein 300 or more of the gate lines and 300 or more of the source lines are provided in each inch.

12. The liquid crystal display device according to claim 7, wherein the oxide semiconductor has a wider band gap and a lower intrinsic carrier density than silicon.
